(19) United States
(12) Patent Application Publication
(10) Pub. No.: US 2009/0132287 A1
(43) Pub. Date: May 21, 2009

(54) SYSTEM AND METHOD FOR PROVIDING AUTOMATED MEDICAL ANALYSIS

(76) Inventors: John M. Spivey, Jackson, MS (US); Robert L. Harris, Jackson, MS (US)

Correspondence Address: DITTHAVONG MORI & STEINER, P.C., 918 Prince St., Alexandria, VA, 22314, US

(21) Appl. No.: 12/275,851

(22) Filed: Nov. 21, 2008

Related U.S. Application Data
(60) Provisional application No. 60/989,627, filed on Nov. 21, 2007.

(51) Int. Cl. G06Q 10/00; G06Q 50/00

(52) U.S. Cl. 705/3; 705/9

(57) ABSTRACT

An approach is provided for automated medical analysis. A request is received over a data network from a physician to schedule a urodynamic study on a patient as part of a managed service. The request is stored in a repository configured to store a plurality of requests corresponding to a plurality of physicians. A technician is scheduled, based on the requests, to perform the urodynamic study at a location of the physician. Information collected by the technician during the urodynamic study is stored in the repository to a patient profile.

### RELATED APPLICATIONS

This application claims the benefit of the earlier filing date under 35 U.S.C. 119(e) of U.S. Provisional Application Ser. No. 60/989,627 filed Nov. 21, 2007, entitled “System and Method for Providing Automated Medical Analysis,” the entirety of which is incorporated herein by reference.

### BACKGROUND INFORMATION

Advances in communication technologies have permitted their adaptation to many fields. Traditionally, however, the medical field has been slow to integrate such technologies because of the challenges with legacy systems and procedures. Additionally, the critical and sensitive nature of medical diagnosis and associated records requires that the information technology (IT) infrastructure be highly reliable and secure. Furthermore, given the specialized nature of medicine, knowledge has become more and more concentrated within a smaller group of highly specialized individuals. Consequently, these individuals need to handle an ever increasing number of cases. Conventional IT systems have not been adapted to enable more efficient utilization of specialized knowledge.

One medical specialty area, for example, is that of urinary incontinence (UI), i.e., the inability to maintain voluntary control of micturition. UI affects a vast number of individuals and typically results in the involuntary excretion of urine during the course of normal daily activities or bodily movements, such as: laughing, coughing, sneezing, and exercising. As a result, many individuals suffer a greatly impacted, if not totally diminished, level of self-confidence and long-term quality of life. Further, because of the socially and hygienically objectionable nature of the condition, many individuals feel too embarrassed and/or uncomfortable to engage in basic activities. In fact, some of the UI afflicted choose to preserve what sense of personal dignity they feel remains at the expense of engaging in beneficial diagnostic procedures and treatment. Compounding the plight, women tend to be more susceptible to becoming incontinent than men, and typically live a much larger fraction of their life suffering from the condition. Consequently, adult female UI is becoming an ever increasing public health concern in terms of monetary and resource expenditures.

Therefore, there is a need for an approach that provides more effective and efficient techniques for automated medical analysis and, in particular, for assessing urinary functions.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of facilitating urodynamic studies as part of a managed service, according to an exemplary embodiment;

FIG. 2 is a diagram of a medical diagnostic platform, according to an exemplary embodiment;

FIG. 3 is a flowchart of a process for facilitating urodynamic studies as part of a managed service, according to an exemplary embodiment;

FIGS. 4 and 5 are flowcharts of respective processes for generating physician and patient profiles, according to exemplary embodiments;

FIGS. 6A-6F are diagrams of user interfaces for facilitating the processes of FIGS. 4 and 5, according to exemplary embodiments;

FIG. 7 is a flowchart of a process for scheduling urodynamic studies, according to an exemplary embodiment;

FIGS. 8A-8E are diagrams of user interfaces for facilitating the process of FIG. 7, according to exemplary embodiments;

FIG. 9 is a flowchart of a process for managing urodynamic study information, according to an exemplary embodiment;

FIG. 10 is a flowchart of a process for generating urodynamic study reports, according to an exemplary embodiment;

FIGS. 11A-11G are diagrams of user interfaces for facilitating the processes of FIGS. 9 and 10, according to exemplary embodiments; and

FIG. 12 is a diagram of a computer system that can be used to implement various exemplary embodiments.

### DESCRIPTION OF THE PREFERRED EMBODIMENT

A preferred apparatus, method, and software for providing automated medical analysis are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to managing urodynamic studies, it is contemplated that various exemplary embodiments are also applicable to managing other health-related procedures, such as coronary function studies, pulmonary function studies, and the like. It is also noted that while various exemplary embodiments are described with respect to the anatomical structure of a woman, it is contemplated that various exemplary embodiments are also applicable to male anatomical structures, as well as other equivalent specie anatomies.

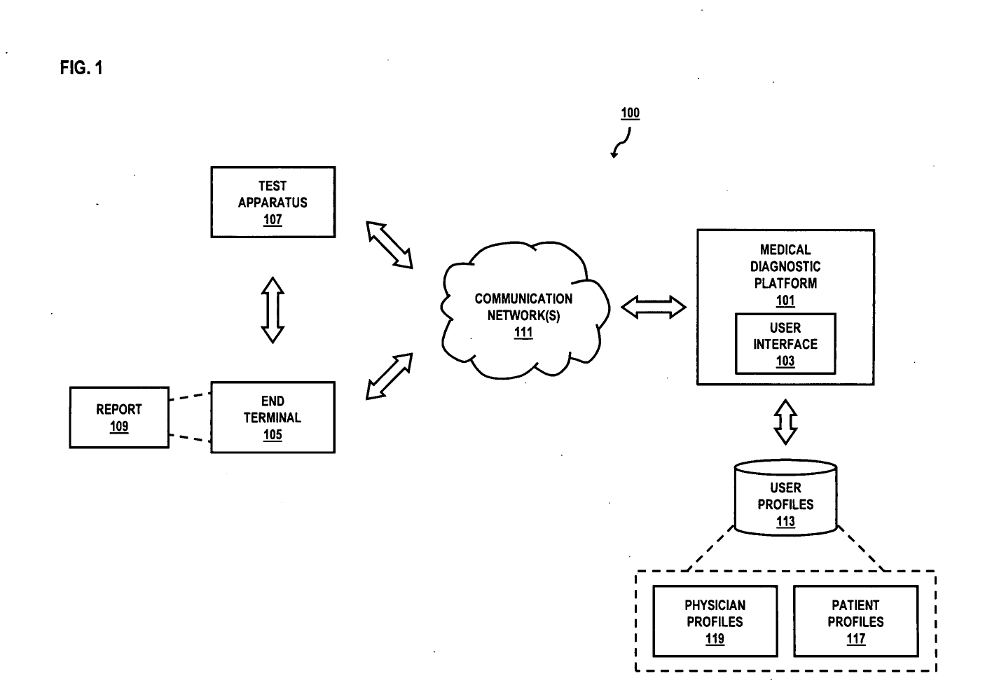

FIG. 1 is a diagram of a system capable of facilitating urodynamic studies as part of a managed service, according to an exemplary embodiment. For the purposes of explanation, a system 100 including medical diagnostic platform 101 configured to make an interface (e.g., user interface 103) available for managing medical diagnostic procedures, is described with respect to managing urodynamic procedures for the rendering of differential diagnoses and treatment regimens related to urinary incontinence (UI). In this manner, user interface 103 may be configured to enable users, via one or more client devices (e.g., end terminal 105 and/or test apparatus 107) to input objective and subjective symptomatic and diagnostic indicia, schedule and conduct urodynamic studies, upload information collected during urodynamic studies, and generate, modify, and review reports (e.g., report 109) providing a differential diagnosis and one or more treatment regimens. As such, user interface 103 may be made available to different subsets of users (e.g., patients, primary care physicians, technicians, and interpreters) at varying levels of access in order to effectuate the processes described herein. While specific reference will be made hereto, it is contemplated that system 100 may embody many forms and include multiple and/or alternative components and facilities.

For healthy individuals, waste storage and active expulsion of urine are functions of the lower urinary tract; however, ultimate mediation is governed by the peripheral autonomic nervous system. Sensory inputs and control signals are directly communicated to the lower urinary tract by the nervous system to regulate urinary functions and induce micturition. In turn, these autonomic functions are facilitated, inhibited, and coordinated by higher neurologic levels such that waste storage and evacuation occurs at socially acceptable limits. When urine is involuntarily excreted at socially or hygienically objectionable moments, a dysfunction of the lower urinary tract results called urinary incontinence (“UI”). One method of diagnosing such conditions is to conduct urodynamic studies that assist physicians in developing treatment options for their patients. Before describing an exemplary approach of system 100, a better understanding of the modulation of the autonomic lower urinary tract function by the central nervous system is described.

At an organizational level, the physiology of normal waste storage and evacuation is controlled by four loops of the central nervous system, i.e., the cerebral-brain stem loop, the brain stem-sacral loop, the vesical-sacral-sphincter loop, and the cerebral-sacral loop. The cerebral-brain stem loop (“loop I”) provides for volitional control of detrusor urinae muscle activity, i.e., it provides for conscious contraction control of the muscle fibers capable of suppressing the micturition reflex. Such suppression is an acquired skill learned during childhood bladder training. Anatomically, loop I arises from the frontal cerebral cortex and terminates in the pontine mesencephalic reticular formation, i.e., the brain stem micturition center. A variety of central disease processes can adversely affect the integrity of this loop including central disorders such as: Parkinson's disease, brain tumors, trauma, vascular disease, or multiple sclerosis. For women, however, the loss of voluntary detrusor control is most commonly idiopathic or the result of local irritative processes occurring at, in, or around the bladder and urethra regions.

The brain stem-sacral loop (“loop II”) permits one to consciously sustain detrusor contraction during micturition in order to achieve total bladder evacuation. The efferent limb of loop II originates in the brain stem micturition center and terminates in the second through fourth sacral segments of the sacral micturition center. Dysfunctions of loop II can result from diseases and/or injuries to the spinal cord causing detrusor areflexia and/or urinary retention; however, the afferent limbs of loop I and II are not further considered.

During micturition, the vesical-sacral-sphincter loop (“loop III”) coordinates urethral skeletal sphincter relaxation and detrusor contractions. Such reflex coordination was originally believed to occur via interneurons passing between the detrusor and pudendal sacral nuclei contained within the sacral micturition center. However, there is considerable experimental and clinical evidence locating coordination control at the suprasacral level in an intact individual, presumably in the pons. Dysfunctions of loop III can be the result of advanced multiple sclerosis, spinal cord injury, peripheral neuropathy, and local irritative lesions leading to detrusor external sphincter dyssynergia.

At the cerebral-sacral loop (“loop IV”), volitional control of the striated urethral sphincter takes place. Loop IV originates from the frontal lobe of the cerebral cortex and terminates in the sacral pudendal motor neurons. A variety of lesions of the brain, spinal cord, and peripheral nerves can interfere with one's ability to voluntarily contract and/or exercise their striated urethral sphincter muscles. Additionally, anatomic factors and skeletal muscle deterioration can transpire at childbirth and continue through (or arise later during) adulthood to further compromise the aforementioned inabilities. For continent individuals, reflexive urethral relaxation can be actively compensated for by consciously contracting their striated sphincter muscles. Disturbances caused by urinary incontinence impede willful attempts at such compensation.

Bounding nervous control of urine storage and evacuation are the operating characteristics of an individual's sympathetic nervous system and the elastic properties of their bladder wall to permit bladder filling with relatively small changes in bladder pressures. Loops I and IV promote storage functions by effectuating an individual's conscious desire to suppress the micturition reflex and contract the striated sphincter, respectively. The parasympathetic nervous system regulates micturition by constricting the detrusor and relaxing the smooth muscle of the bladder neck and urethra. Thus, the micturition reflex is organized and facilitated by loop II, whereas reflexive coordination of the striated sphincter during micturition is managed by loop III.

While some symptoms of lower urinary tract dysfunctions result from degraded central nervous modulation, most often a central lesion is either unidentifiable or not specifically treatable. Thus, urinary conditions are often diagnosed and managed symptomatically by altering the dysfunctional status of the bladder and/or urethra using pharmacologic agents. More often than not, agents capable of producing autonomic effects are used. Table 1 summarizes the autonomic nervous system's effects on the bladder and urethra so as to convey an understanding of autonomic control of the lower urinary tract.

TABLE 1

| | Parasympathetic | Sympathetic | |
|---|---|---|---|
| Spinal Cord Origin | S2 to S4 | T10 to L2 | |
| Preganglionic Fiber | Long | Short | |
| Neurotransmitter | Acetylcholine | Acetylcholine (Nicotinic) | |
| | (Nicotinic) | | |
| Postganglionic Fiber | Short | Long | |
| Neurotransmitter | Acetylcholine | Norepinephrine | |
| | (Muscarinic) | | |
| Nerve | Pelvic | Hypogastric | |
| | | Alpha | Beta |
| Urethral Effect | Relaxation^{a} | Contraction | Relaxation^{b} |
| Detrusor Effect | Contraction | Relaxation^{c} | Relaxation^{d} |

^{a}Due to inhibitory muscarinic receptors on adrenergic nerves blocking release of norepinephrine
^{b}Alpha receptors predominate in the urethra
^{c}Direct detrusor effect is contraction - most fibers terminate on parasympathetic ganglia and suppress activity to create a net effect by alpha stimulation of relaxation.
^{d}Beta fibers predominate in the bladder.

Traditionally, conducting urodynamic evaluations have been complex and expensive processes that generally require extensive training. Namely, conventional procedures usually require more time to complete than a primary care physician (PCP) has available for an “ordinary” visit, as well as more specialized knowledge than typical PCPs are equipped with. As such, incontinent individuals are typically referred to UI specialists and, thereby, have to divulge and repetitively disclose their embarrassing symptoms to more doctors than necessary in order to adequately navigate established referral systems. Based on the foregoing, there is a clear need for improved approaches to diagnosing UI, lowering repetitive disclosure demands, providing for more comfortable test environments and procedures, and engaging the PCPs of patients in the process without increasing their burden. Further, there remains a need for enhanced, cost-effective systems for assessing urinary function.

Therefore, the approach according to certain embodiments of system 100 stems from the recognition that providing a managed medical diagnostic service, whereby PCPs can collect initial symptomatic and diagnostic indicia, schedule specialized technicians to perform urodynamic studies within their offices (i.e., sites), and receive reports generated by interpreters extensively trained at rendering differential diagnoses and treatment options for UI related conditions, provides an efficient and convenient technique to enable more comfortable test environments and less onerous procedures, as well as engage PCPs within the process without increasing their burden. Furthermore, the approach also allows more specially trained individuals to conduct and assess urodynamic studies. The approach according to certain other embodiments of system 100 stem from the recognition that providing the managed medical diagnostic service as a paid service to PCPs, whereby a provider of the managed service supplies the implements (e.g., equipment, supplies, etc.) for performing the urodynamic studies, enables a cost-effective technique to improve the standard of care offered to patients, reduce the professional liability upon PCPs, and increase profits to the PCPs. Furthermore, the approach according to certain additional embodiments of system 100 also stem from the recognition that providing a selectively accessible networked interface for aggregating information, conducting urodynamic studies, generating diagnostic reports, and reviewing patient profiles, enables a secure technique to lower repetitive disclosure demands typically thrust upon patients.

Referring to FIG. 1, user interface 103 may be made available to users over one or more communication networks 111 via one or more of end terminal 105 and test apparatus 107, also referred to as client devices 105 and 107. In this manner user interface 103 may be executable, for example, as one or more graphical user interfaces (GUI) capable of local or networked implementation on client devices 105 and 107, such as any suitable computing device, telephony device, mobile device, or other like mechanism. Computing devices may include one of a desktop computer, notebook computer, server, terminal, workstation, customized hardware, etc. Telephony devices may include one of a plain-old-telephone, wireless telephone, cellular telephone, satellite telephone, voice-over-internet protocol telephone, fax machine, and the like. Mobile devices may include personal digital assistants (PDA), pocket personal computers, smart phones, tablets, handsets, and customized hardware, as well as other mobile technologies capable of receiving and/or transmitting data. In this regard, end terminal 105 may be used in combination with test apparatus 109, such as a urodynamic test apparatus, so as to port information (e.g., information collected during a urodynamic study) directly as it is measured to user interface 103, or have statistics manually entered during or after clinical examination. It is also noted that information may be shared between various types of end terminals 105, such as between a stationary end terminal (e.g., a desktop computer) and a mobile end terminal (e.g., a smart phone).

According to various exemplary embodiments, medical diagnostic platform 101 and, thereby, user interface 103 may be made available to client devices 105 and 107 over one or more communication networks 111. Exemplary networks 111 may include telephony networks, data networks, wireless networks, or combinations thereof. Accordingly, networks 111 may comprise one or more of the public switched telephone network (PSTN), a private telephony network, the internet, an intranet, a local area network (LAN), a wide area network (WAN), a cellular network, a satellite network, a cable network, a fiber optic network, etc. In this way, client devices 105 and 107 may be stand-alone devices or may exhibit combined functionality of one or more of devices 105 and 107. For instance, end terminal 105 may be combined into a single entity with test apparatus 107. In other instances, client devices 105 and 107 may be configured to exchange information, such as over one or more communication networks 111 or via one or more local interfaces, e.g., serial port, parallel port, infrared (or other wireless) port, etc. As such, client devices 105 and 107 may remotely access medical diagnostic platform 101 that is configured to execute multiple instances of user interface 103, such as a urodynamic diagnostic interface, provided in the form of a conventional application service provider (ASP). In this way, medical diagnostic platform 101 may obtain information from client devices 105 and 107 via graphical interface, textual interface, audile interface, or other like schema. Further, information may be manipulated and/or stored locally at client devices 105 and 107, or remotely accessed from one or more repositories, e.g., user profiles repository 113.

It is noted that utilization of an ASP or other like architecture enables system scalability in terms of, for example, administrative scalability, geographic scalability, and/or load scalability. For instance, user interface 103 may, according to exemplary embodiments, be implemented as one or more hypertext markup language (HTML) user interfaces or JAVA applets provided by medical diagnostic platform 101 and, thereby, accessed via one or more world-wide-web pages. Thus, multiple users and/or instances of user interface 103 may be simultaneously realized.

According to exemplary embodiments, information may be input to medical diagnostic platform 101 via website entry (e.g., data fields, pull-down menus, radio button selections, scalars, checkboxes, etc.), instant messaging, electronic mail, text messaging, facsimile, voice transmission, postal mailing, or other form of specifically designed hardware or software application. For example, information may be input via a plain-text, standard language (or near equivalent) format. In exemplary embodiments, the input may be parsed into appropriate field parameters, as well as stored to corresponding fields within one or more profiles of user profiles repository 113.

It is also contemplated that information may be input and reviewed in one format, and then synchronized to another for transmission. For instance, when a user transmits information in a voice format, medical diagnostic platform 101 may optionally include a text-to-speech (TTS) and/or an automatic speech recognizer (ASR) engine for converting analog to digital signals and vice versa. As such, when a user interacts with user interface 103 via voice transmission, the ASR can covert the spoken language (i.e., an analog signal) of a user into textual form (e.g., a digital signal) for processing by, for instance, medical diagnostic platform 101. Meanwhile, the TTS engine may covert textual information (e.g., a digital signal) from medical diagnostic platform 101 to speech (e.g., an analog signal) for playback to the user. In this manner, a user may interact with user interface 103 by sending and receiving information using voice protocols, e.g., voice extensible markup language (VXML) programs. It is recognized that the optionally provided TTS and ASR engines may be collocated or integrated within medical diagnostic platform 101 or one or more of communication networks 111. Further, TTS and/or ASR functionality may be implemented on one or more of client devices 105 and 107.

As previously mentioned, user profiles repository 113 may be configured to store a plurality of profiles, e.g., patient profiles 117 corresponding to a plurality of patients exhibiting UI symptoms and physician profiles 119 corresponding to a plurality of PCPs servicing one or more of the aforementioned patients. While not illustrated, user profiles repository 113 may also be configured to store a plurality of additional profiles corresponding to technicians trained to perform urodynamic studies on the aforementioned patients and interpreters trained to assess information collected by the technicians during the urodynamic studies.

At a complementary end of the spectrum, resulting information, diagnoses, and treatment recommendations may be made available to users through, for instance, a graphical, textual, audile, and/or other user interface 103 presented via one or more of client devices 105 and 107, downloaded as a file or email via one or more of client devices 105 and 107, printed in paper form, received as a hard copy via postal service, delivered as a facsimile, etc. Thus, embodiments of user interface 103 enable a variety of interfacing techniques via a variety of client devices, such that a user can utilize any single or combined technique. Furthermore, user interface 103 may be implemented one or more of client devices 105 and 107 in any suitable environment, e.g., at a home or workplace of a patient or physician, at strategically placed testing centers, etc. In this regard, urodynamic studies can occur in an environment tailored to a level of comfort embarrassment, or desire for increased privacy of a patient.

When system 100 is implemented as an ASP infrastructure, medical diagnostic platform 101 may be configured to manage and facilitate multiple environments, urodynamic studies, and levels of users. In this manner, medical diagnostic platform 101 essentially provides system intelligence in the form of account management, access control, and data warehousing. It is noted that user profiles repository 113 may be made available to client devices 105 and 107 and/or medical diagnostic platform 101 for storing pertinent information, such as symptomatic and diagnostic indicia, information collected during a urodynamic study, one or more schedules for conducting or performing urodynamic studies, etc. Although a single repository is shown, the functionality of user profiles repository 113 may be distributed in a database management system. In other embodiments, user profiles repository 113 may be collocated with or integrated into medical diagnostic platform 101 and/or client devices 105 and 107. While not illustrated, medical diagnostic platform 101 may take the form of an online system capable of communicating with one or more third-party web servers, or other equivalent online system, via one or more of communication networks 111 to provide users with other avenues of interaction with the functionality of medical diagnostic platform 101. As such, embodiments user interface 103 can be embedded into, linked with, and/or pushed to various online or offline environments.

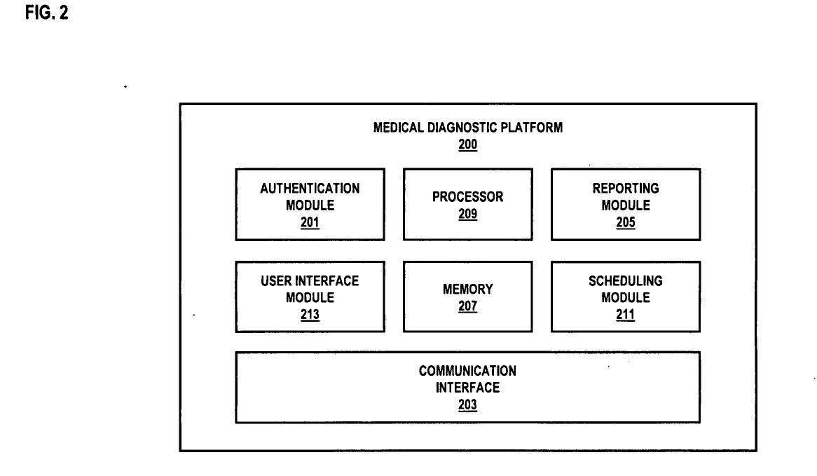

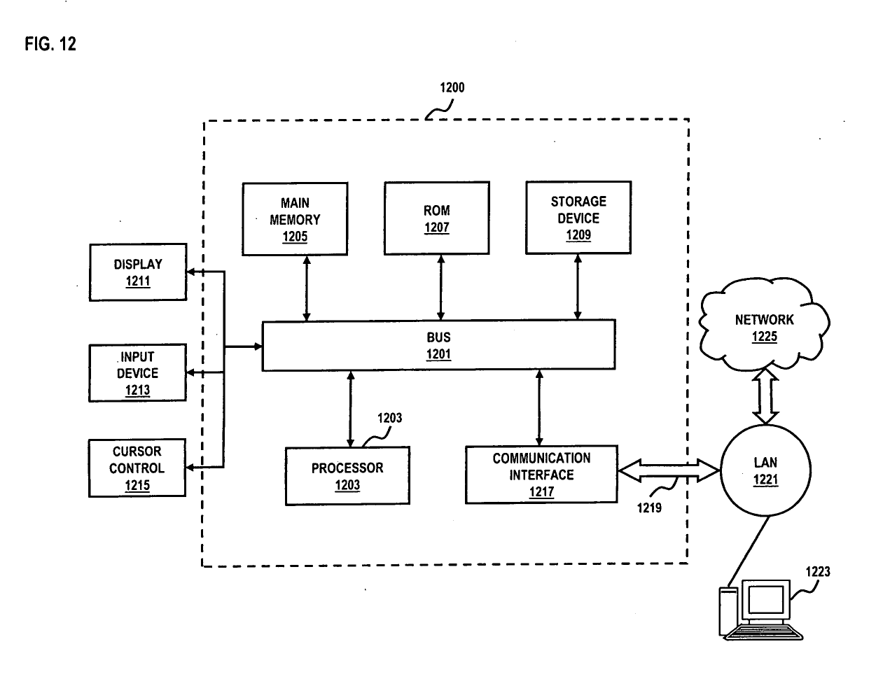

FIG. 2 is a diagram of a medical diagnostic platform, according to an exemplary embodiment. Medical diagnostic platform (or platform) 200 may comprise computing hardware (such as described with respect to FIG. 12), as well as include one or more components configured to execute the processes described herein. In one implementation, platform 200 includes authentication module 201, communication interface 203, reporting module 205, memory 207, processor 209, scheduling module 211, and user interface module 213. It is noted that components 201-213 may provide shifting operations depending upon the classification of a user (e.g., primary care physician, technician, interpreter, etc.) accessing platform 200. In turn, platform 200 may communicate with one or more repositories, such as user profiles repository 113, as well as made accessible to users via client devices 105 and/or 107. It is contemplated; however, that platform 200 may embody many forms and include multiple and/or alternative components. For example, it is contemplated that components of platform 200 may be combined, located in separate structures, or separate locations. Accordingly, platform 200 may be configured as, or be distributed between, one or more frontend, middleware, and/or backend servers accessible over one or more of communication networks 111. Namely, a specific topology is not critical to embodiments of platform 200 or system 100.

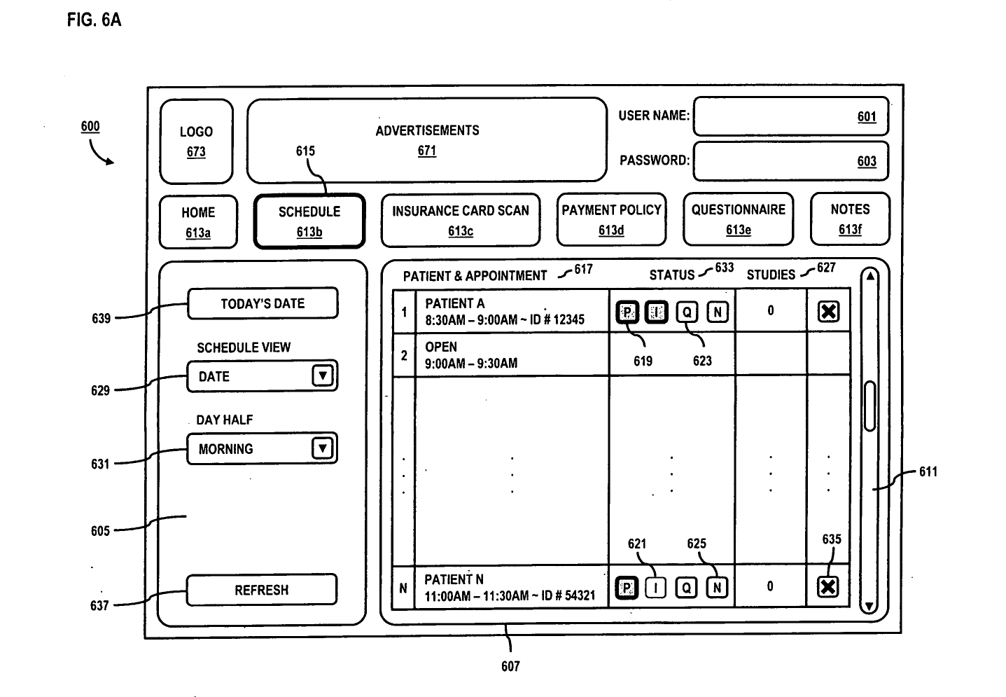

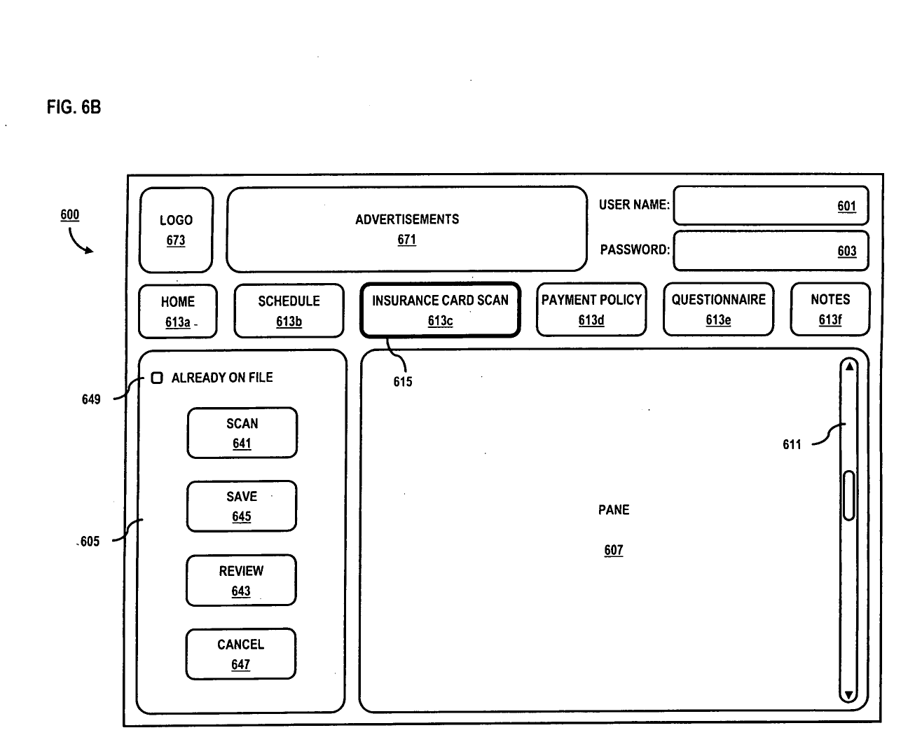

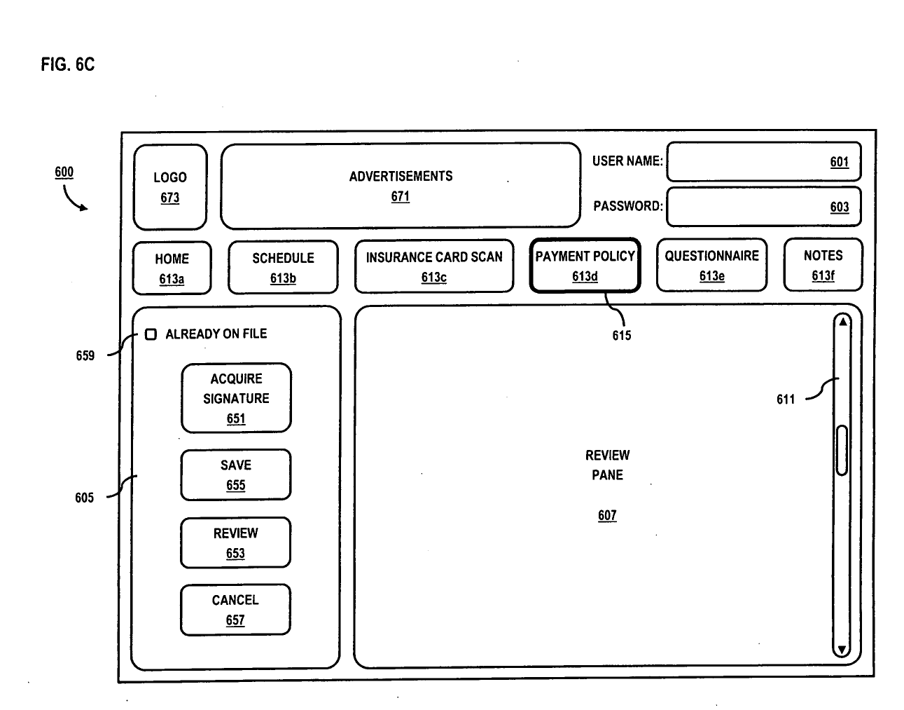

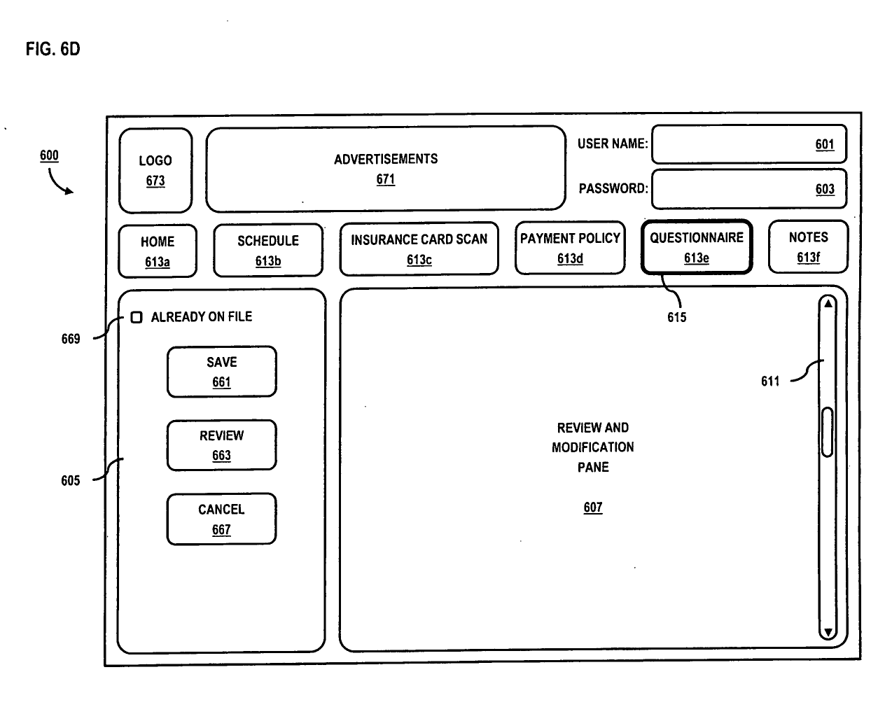

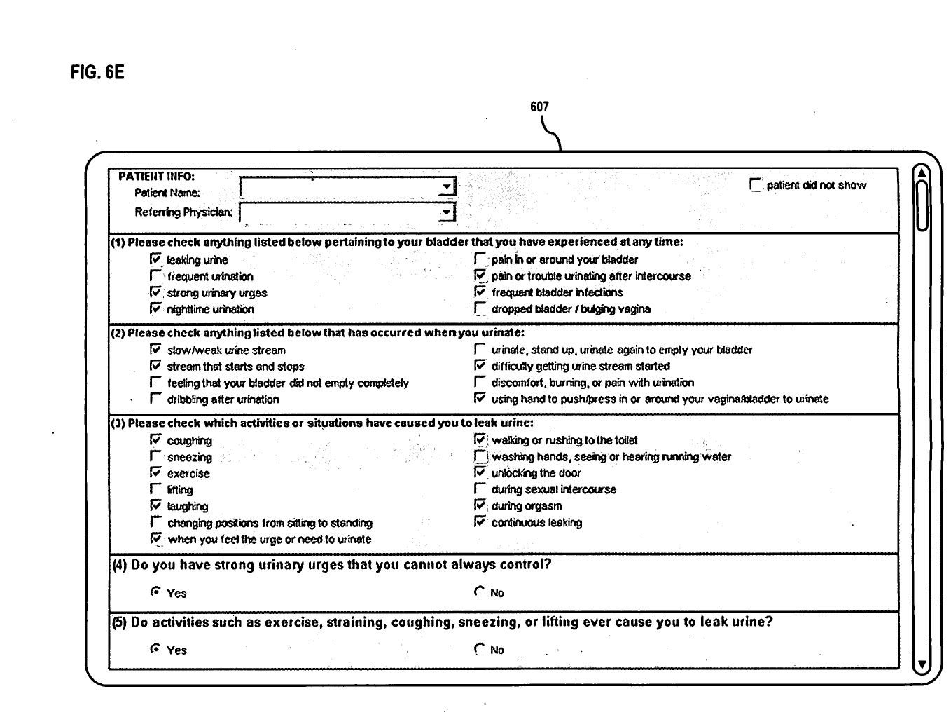

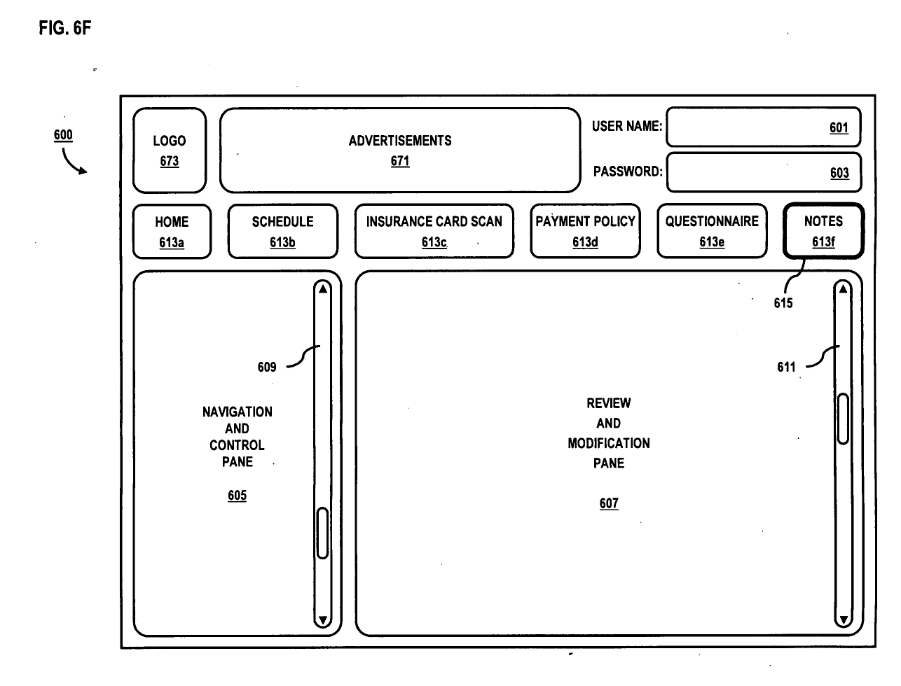

According to exemplary embodiments, platform 200 enables users (or subscribers) to create and configure one or more profiles (e.g., PCP profiles, patient profiles, etc.) for managing one or more urodynamic studies. In this manner, platform 200 provides a user interface module 213, e.g., a networked portal, to permit user access to the features and functionality of platform 200 via one or more of client devices 105 and 107. User interface module 213, in exemplary embodiments, may be configured for exchanging information between client devices 105 or 107 and a web browser or other networked-based application. As such, user interface module 213 may execute one or more graphical user interface (GUI) applications as part of user interface 103 that are configured to provide users with one or more menus of options, input fields, selections, etc., for inputting objective and subjective symptomatic and diagnostic indicia, scheduling and conduct urodynamic studies, uploading information collected during urodynamic studies, and generating, modifying, and reviewing reports (e.g., report 109) providing differential diagnoses and one or more treatment regimens for conducted urodynamic studies, as well as engage with the other features of the managed medical diagnostic service of system 100. Exemplary GUIs are described in more detail in accordance with FIGS. 6A-6F, 8A-8D, and 11A-11G.

Accordingly, user interfaces (e.g., GUIs) of user interface module 213 may be presented in one or more windows of a conventional browser application. According to certain embodiments, the GUI(s) may be generated and presented in one or more windows controlled by end terminal 105 and, when feasible, test apparatus 107. By way of example, end terminal 105 may have access to one or more user interfaces (e.g., user interface 103) that provide soft and/or hard controls for creating and configuring user profiles, inputting objective and subjective symptomatic and diagnostic indicia, scheduling and conducting urodynamic studies, uploading information collected during urodynamic studies, and generating, modifying, and reviewing reports (e.g., report 109) providing differential diagnoses and one or more treatment regimens for patients afflicted by UI, as well as interfacing with other functions and features of the managed medical diagnostic service of system 100. Hence, the GUI(s) of user interface module 213 (or corresponding client devices 105 and 107) may comprise pages of both textual and graphical information, as well as various interactive control widgets, through which users may access and interact with platform 200. In turn, users at end terminal 105 and/or test apparatus 109 can be permitted to input commands to user interface module 213 to control or otherwise manipulate the managed service of system 100.

User interface module 213 may be implemented in conjunction with scheduling module 211 to schedule technicians to perform urodynamic studies at offices (location, site or premise) of one or more primary care physicians. In this manner, primary care physicians may interact with user interface module 213 via, for example, end terminal 105 to generate requests for scheduling urodynamic studies on patients as part of the managed service of system 100. Communication interface may be configured to receive these requests and to provide them to scheduling module 211 for scheduling the technicians. It is also contemplated that communication interface may port (or transmit) the requests to any suitable memory of system 100, such as memory 207, user profiles repository 113, etc. According to exemplary embodiments, scheduling module 211 schedules technicians to perform urodynamic studies at offices of the PCPs based on a plurality of requests, so as to ensure sufficient resources and technicians are available to perform the urodynamic studies. In this manner, the requests generated by physicians may include scheduling information, e.g., date, time, location, requesting physician, requested technician, type of urodynamic study require, etc., which may also be utilized by scheduling module 211 to schedule the technicians and/or implements (e.g., equipment, supplies, etc.) for performing the urodynamic studies.

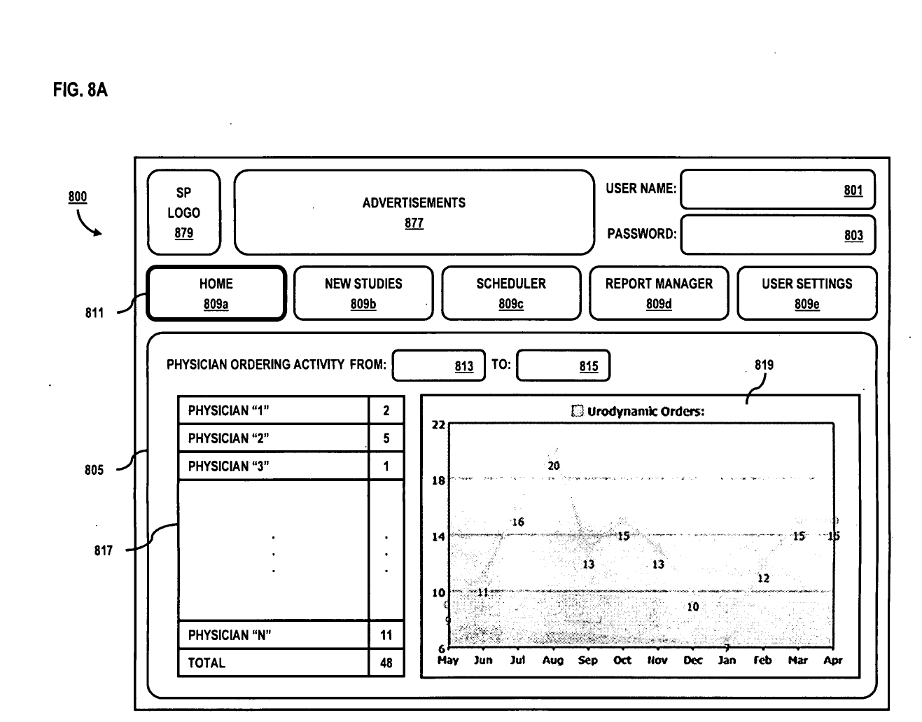

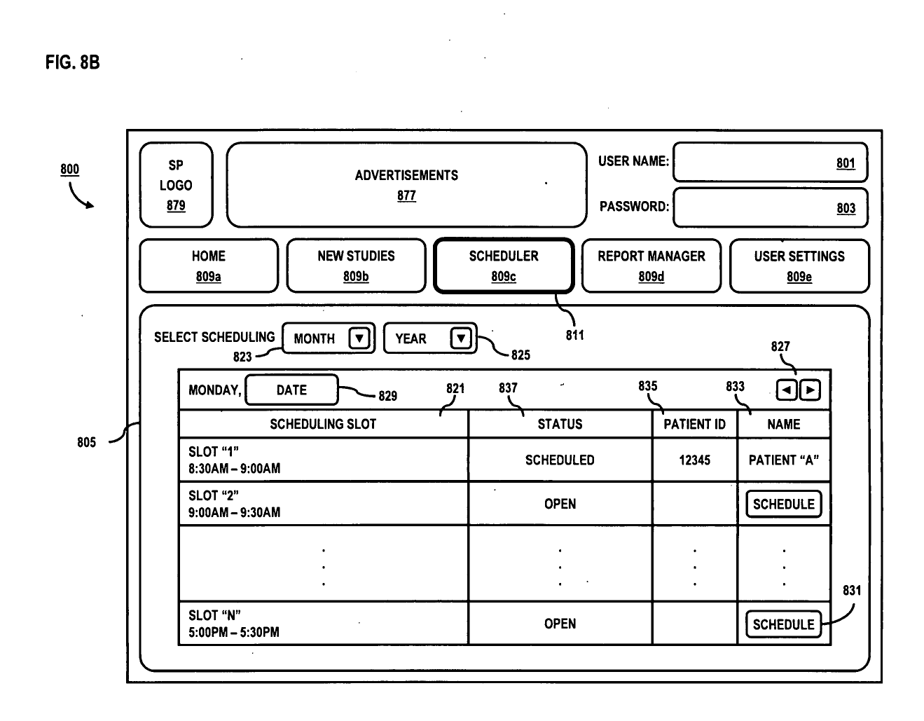

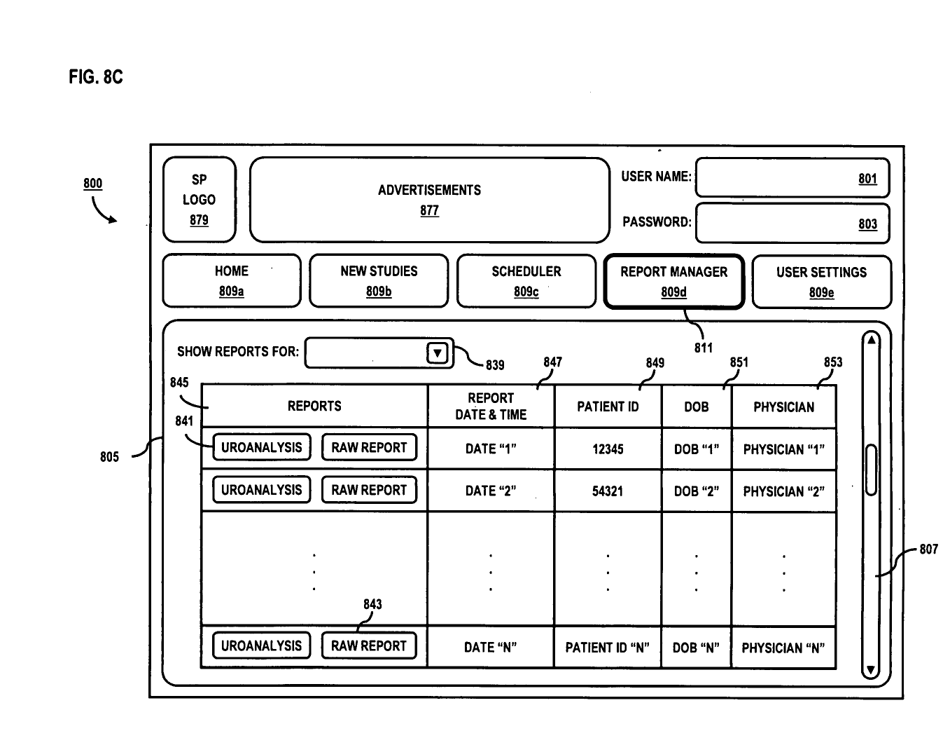

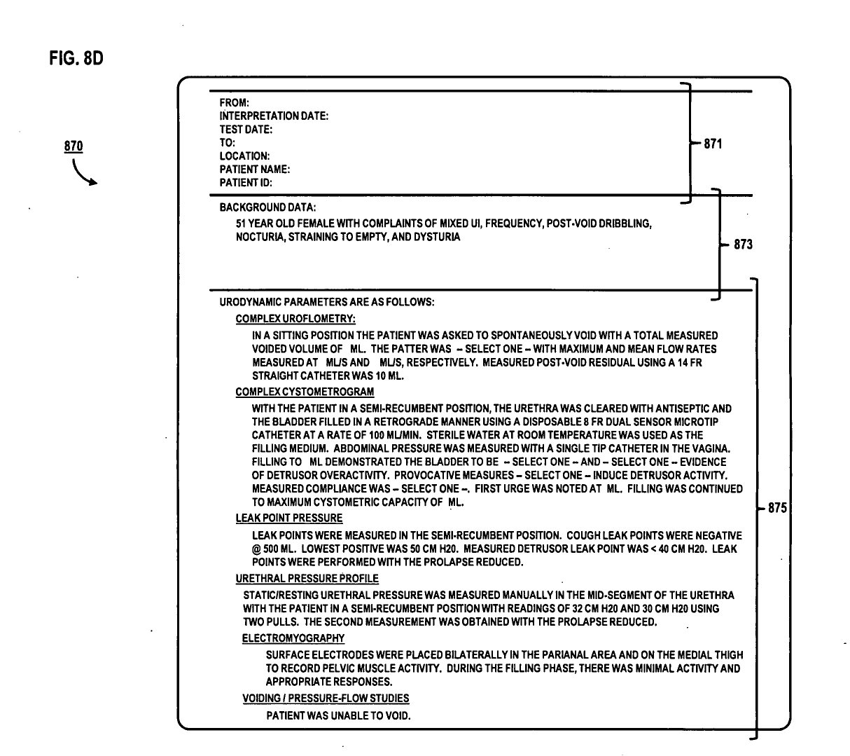

Upon scheduling one or more technicians, as well as suitable implements for the technicians to use to perform the urodynamic studies, scheduling module 211 may store corresponding scheduling information to any suitable memory of system 100, such as memory 207, user profiles repository 113, and/or a memory of client devices 105 or 107. As such, communication interface 203 may be utilized by scheduling module 211 to transmit the scheduling information over one or more of communication networks 111 to one or more of the aforementioned storage locations. Moreover, scheduling module 211 may also provide user interface module 213 with the corresponding scheduling information for providing work schedules to the PCPs, technicians, and/or interpreters. Exemplary GUIs for generating requests and presenting scheduling information to users are described in more detail in accordance with FIGS. 6A, 8A, and 8B.

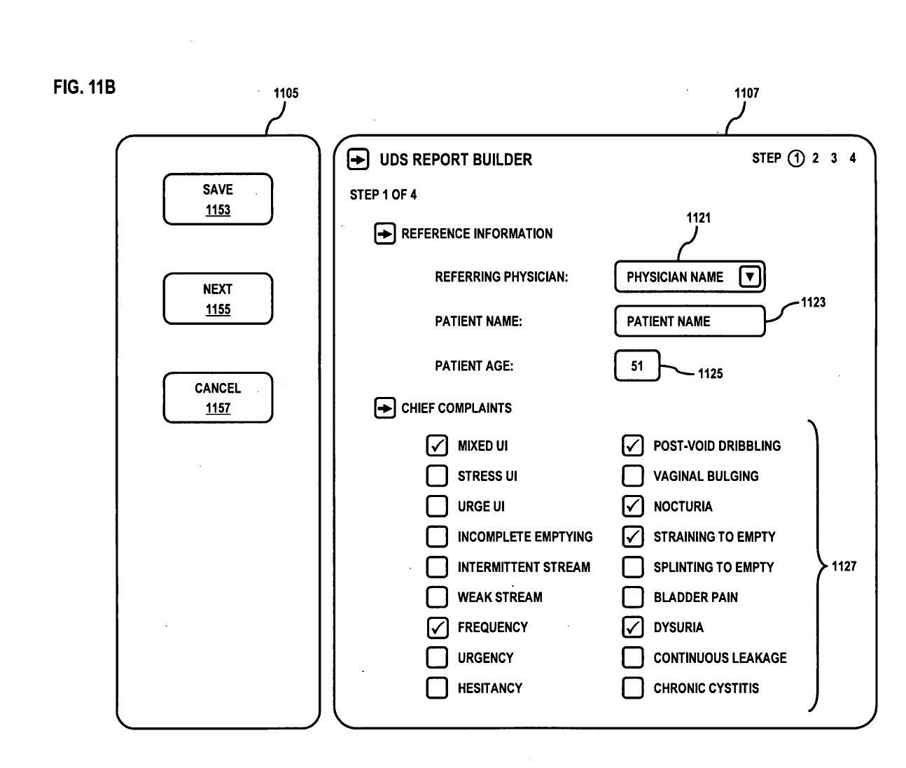

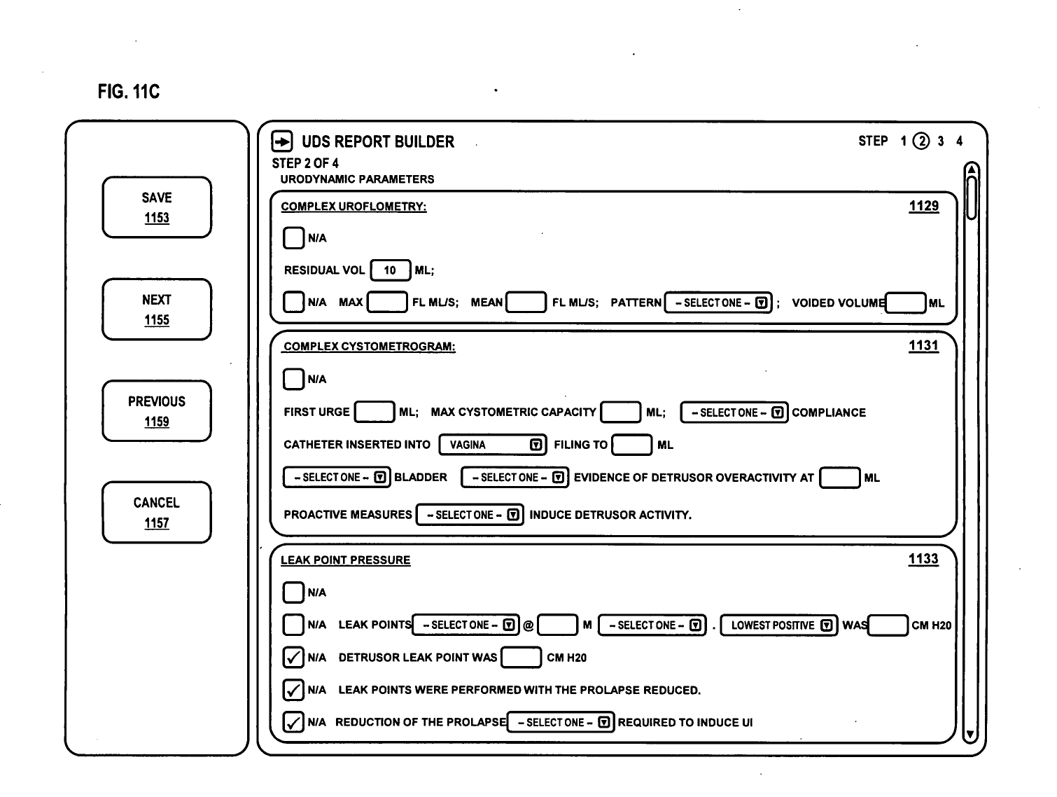

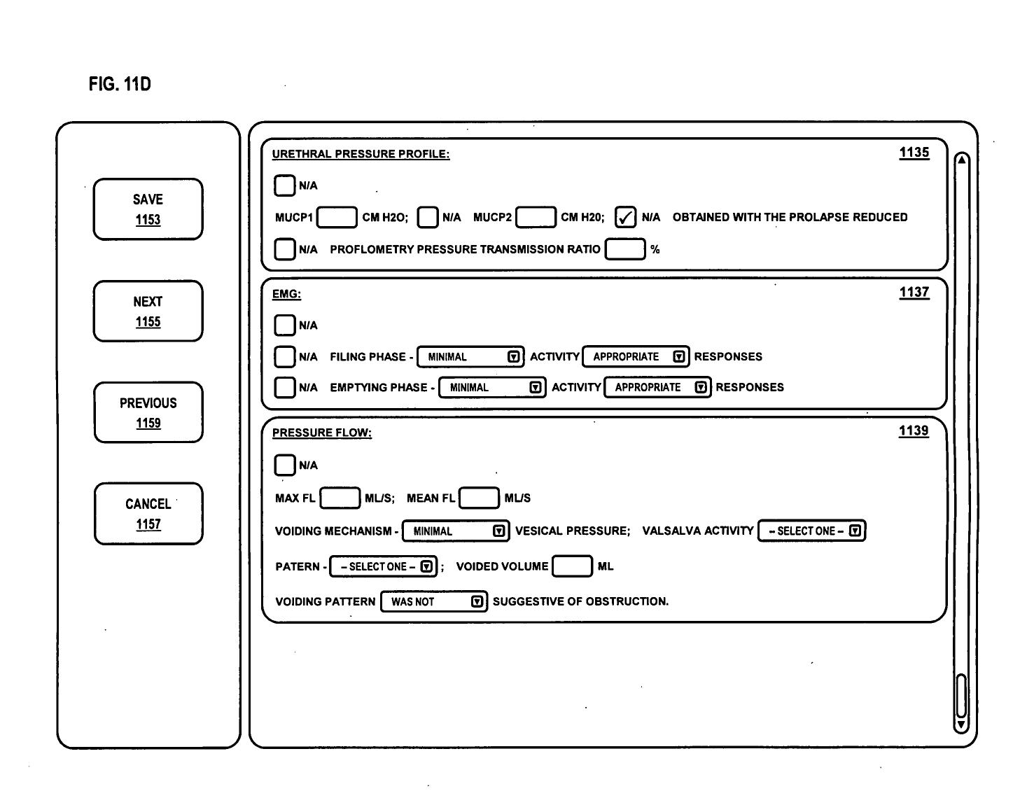

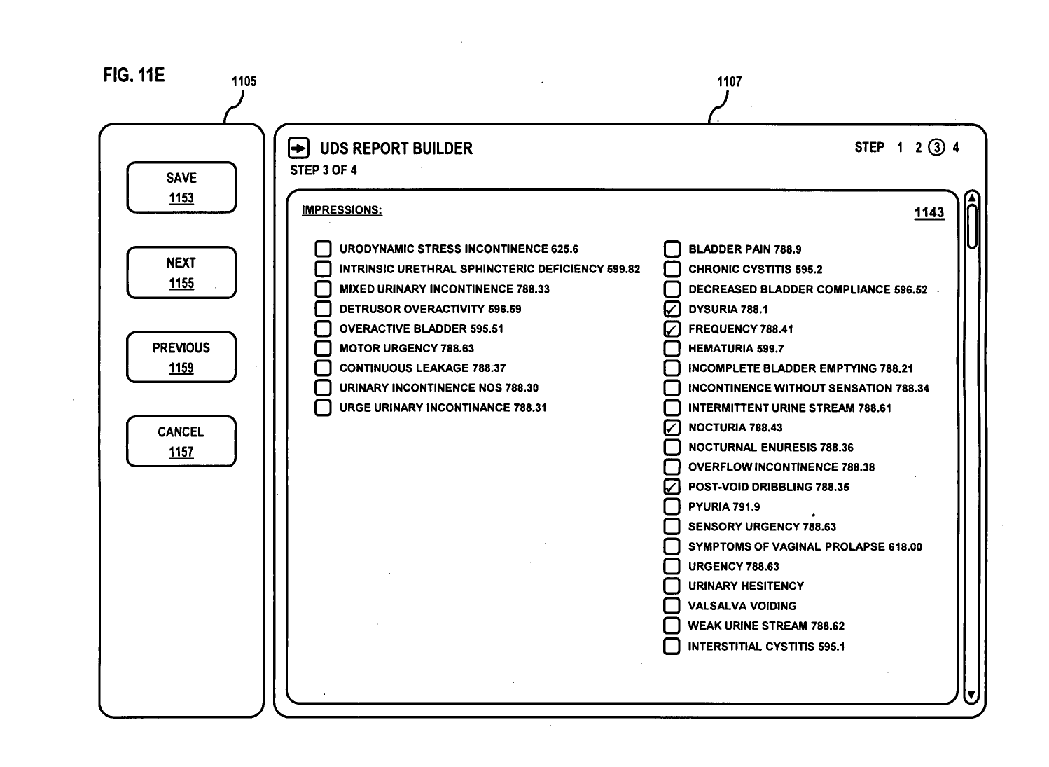

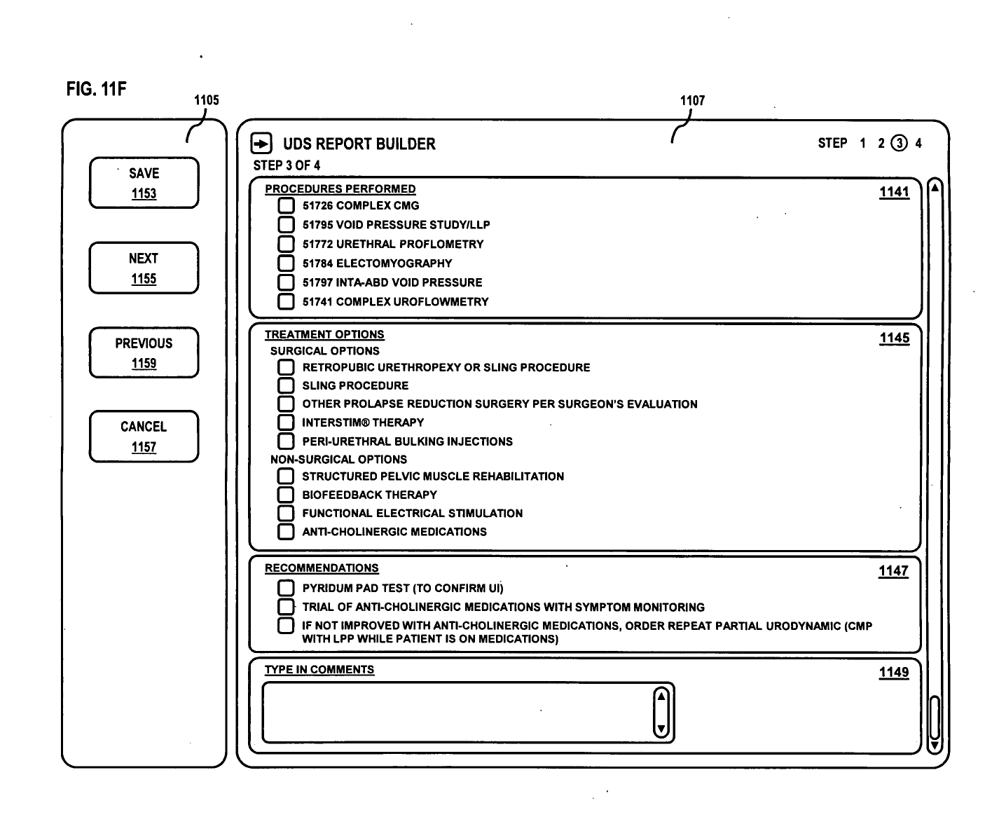

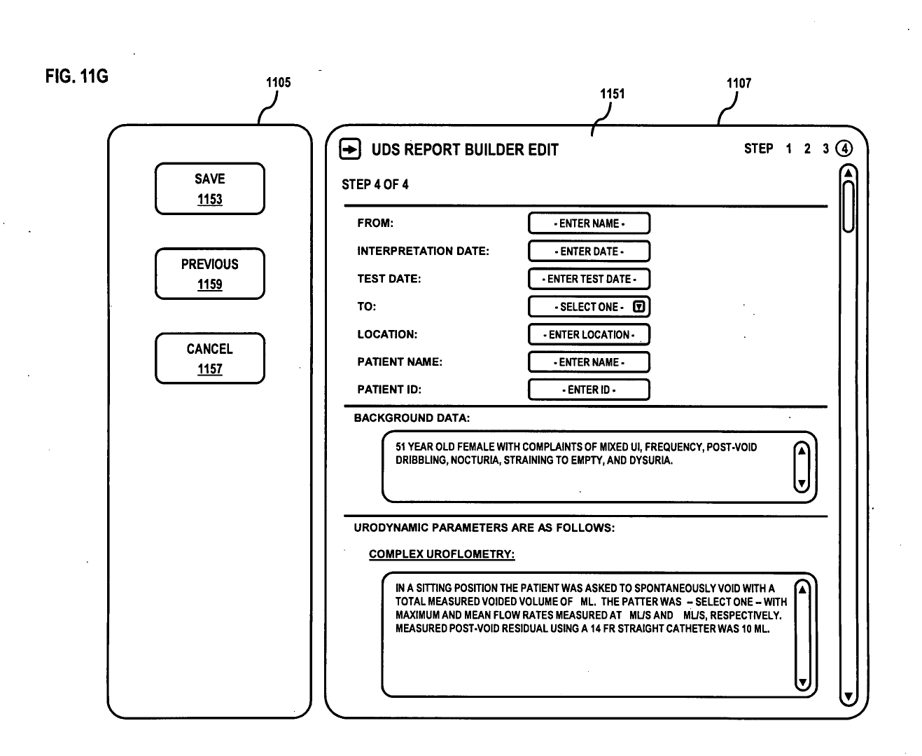

User interface module 213 may also be configured to interact with reporting module 205 for generating reports including diagnostic responses, urinary symptoms, recommended treatments, general patient information, and the like. One or more GUIs may be provided by user interface module 213 and/or reporting module 205 for providing interpreters an interface for generating these reports based on information collected by technicians during performed urodynamic studies, such as the GUIs of FIGS. 11A-11G. In this manner, reporting module 205 may provide user interface module 213 with reporting information for presenting (e.g., formatting, displaying, etc.) generated reports to users via one or more of client devices 105 and 107, such as the report shown in FIG. 8D. It is also noted that reporting module 205 may, in conjunction with user interface module 213, generate questionnaires, such as the questionnaire of FIG. 6E, for gathering information about patients, such as objective and subjective symptomatic indicia (e.g., urinary symptoms), general personal information, and the like. Reporting module 205 may also be configured to generate reports for providing information concerning the urodynamic ordering activity of a PCP, such as reporting a frequency of ordering urodynamic studies by one or more PCPs subscribed to the managed service of system 100, such as in FIG. 8A. According to other embodiments, reporting module may generate reporting tables for conveying to PCPs, the existence of available reports concerning the results of one or more urodynamic studies, such as in FIG. 8C. One or more of the aforementioned reports may be transmitted to various users over one or more of communication networks 111 via communication interface 203. It is noted that information generated or collected by reporting module 205 and/or user interface module 213 may be stored to any suitable memory of system 100, such as memory 207, user profiles repository 113, and/or one or more memories of client devices 105 and 107. Exemplary GUIs for generating and presenting reports are more fully explained in connection with FIGS. 6E, 8A, 8C, 8D, and 11A-11G.

It is also noted that user interface module 213 may provide (in connection with communication interface 203) an interface for users (e.g., PCPs, technicians, interpreters, etc.) to upload and/or download information collected during basic patient investigations or during urodynamic studies. User interface module 213 and/or communication interface 203 may further be configured to provide an interface for users to upload and/or download generated reports or any other suitable information, such as information stored to user profiles repository 113.

In order to provide selective access to the features and functionality of the managed medical diagnostic services of system 100, platform 200 may include authentication module 201 for authenticating (or authorizing) users to the service. It is contemplated that authentication module 201 may operate in concert with communication interface 203 and/or user interface module 213. That is, authentication module 201 may verify user provided credential information acquired via communication interface 203 or user interface module 213 against corresponding credential information stored within a profile (e.g., PCP profile 119) of repository 115. By way of example, the credential information may include “log on” information corresponding to a user name, password, coded key, or other unique identification parameter, such a personal identification number (PIN). In other embodiments, the credential information may include any one, or combination of, a birth date, an account number (e.g., bank, credit card, billing code, etc.), a social security number (SSN), an address (e.g., work, home, IP, media access control (MAC), etc.), or telephone listing (e.g., work, home, cellular, etc.), as well as any other form of uniquely identifiable datum, e.g., biometric code, voice print, etc. Users may provide this information via client devices 105-109, such as by spoken utterances, dual-tone multi-frequency signals (DTMF), packetized transmission, etc. Unobtrusive security may be provided by positively identifying and screening users based on one or more of the aforementioned credentials which may be seamlessly provided when client devices 105-109 communicate with platform 200, such as a unique circuit-ID, PVC-ID, VLAN-ID, IP address, MAC address, etc. Other unobtrusive measures can be made available via user specific voice prints, etc.

Accordingly, user interface module 213 may also provide users with one or more GUIs for managing user settings that can be configured to customize the various interfaces, e.g., GUIs, displayed to particular users or organizations when “logged on” to platform 200. For instance, the user settings may be modified to change the layout of particular forms or displays according to the preferences or requirements of a particular user or organization. More specifically, a first user may log in to platform 200 to generate a urodynamic report, while a second user may log in to platform 200 to review the same. As such, authentication module 201 may, in conjunction with user interface module 213, be configured to store and/or retrieve user profile information from memory 207, user profiles repository 113, a memory of client device 105 or 107, etc., to adapt the presentation and functionality of the GUIs provided to the various possible users of platform 200.

Additionally, platform 200 may include one or more processors (or controllers) 209 for effectuating the aforementioned managed medical diagnostic services via authentication module 201, communication interface 203, reporting module 205, memory 207, scheduling module 211, and user interface module 213. It is also noted that platform 200 and/or system 100 may further include one or more modules (or systems) for billing and payment purposes. The billing and payment modules may effectuate an automated clearing house (ACH) system, a wire transfer system, a debit card system, a credit card system, or any other suitable electronic funds transfer (EFT) system. As such, the billing and payment modules may interface, over one or more of communication networks 111, with one or more originating depository financial institutions (not shown) and/or one or more receiving depository financial institutions (not illustrated).

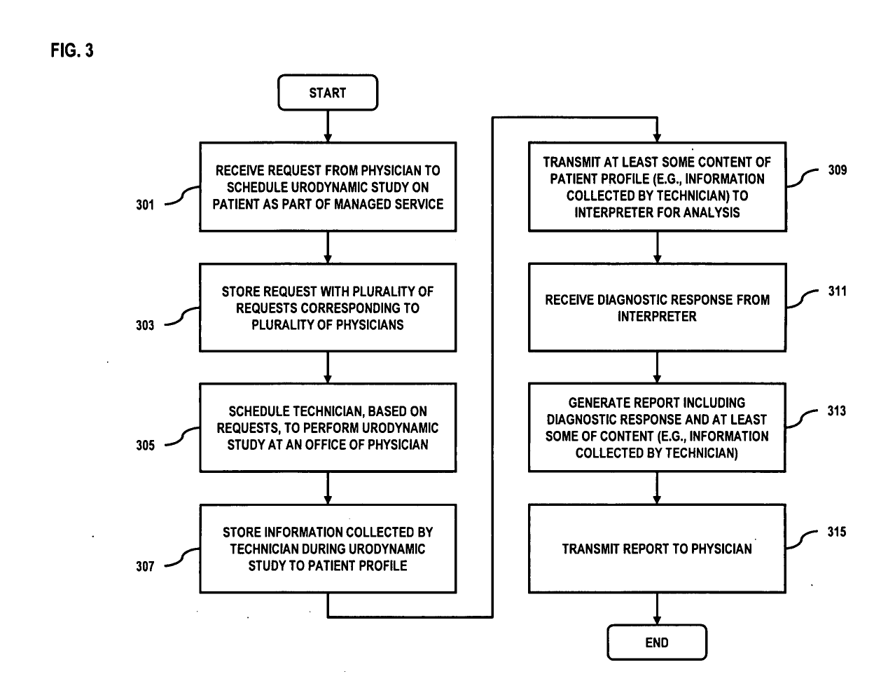

FIG. 3 is a flowchart of a process for facilitating urodynamic studies as part of a managed service, according to an exemplary embodiment. For illustrative purposes, the process is described with reference to FIGS. 1 and 2. It is also noted that the steps of the process may be performed in any suitable order, as well as combined or separated in any suitable manner. At step 301, platform 200 receives a request from a PCP over, for example, one or more of communication networks 111 to schedule a urodynamic study on a patient as part of the managed service of system 100. As previously mentioned, the request may include scheduling information for scheduling the urodynamic study with a specially trained urodynamic technician (UT). It is noted, in particular, that the scheduling information may specify a technician and a suitable location for performing the urodynamic study that is most hospitable to a patient's need for comfort, privacy, and security. For instance, the patient may be most comfortable having the study performed at their PCP's office as opposed to an office of a referred to UT specialist.

Once the request is received by, for example, communication interface 203, the request may be ported (or transmitted) to a suitable storage location for storage, such as memory 207, user profiles repository 113, one or more memories of client devices 105 and 107, etc., per step 303. In this manner, the request may be stored with a plurality of other requests corresponding to a plurality of other physicians. In step 305, these requests may be utilized by, for example, scheduling module 213 to schedule a technician to perform the requested urodynamic study at, for example, a specified location, e.g., an office of the patient's PCP. The scheduled UT will conduct the scheduled urodynamic study utilizing suitable implements (e.g., equipment, supplies, etc.) that may be provided by a provider of the managed service of system 100. Thus, information collected by the UT during the urodynamic study may be uploaded (either in real-time or post-examination) to platform 200 and stored to, for example, patient profile 115 of user profiles repository 113, in step 307.

An interpreting physician may review the information and/or other content stored to patient profile 115 for determining a diagnostic response (e.g., differential diagnosis, recommended treatments, etc.) for the ailments of the patient. As such, communication interface 203 and/or user interface module 213 may transmit at least some content of patient profile 115 to the interpreter for analysis, per step 309. At step 311, the diagnostic response may be received from the interpreter by, for instance, communication interface 203, reporting module 205, and/or user interface module 213. Reporting module 205 may generate a report including the diagnostic response and at least some of the other content (e.g., the information collected by the UT during the urodynamic study) stored to user profile 115, in step 313. Thus, in step 315, the report may be transmitted to the PCP by, for instance, one or more of communication interface 203 and user interface module 213. As such, the PCP may utilize the report to present the patient with a diagnosis of their condition and possible methods of alleviating or solving their problem(s).

A more detailed explanation of the process of FIG. 3, as well as exemplary user interfaces for performing the same will now be provided in relation to the various users of system 100. Apart from system administration and maintenance, three main categories of users are envisioned, i.e., primary care physicians (PCP), urodynamic technicians (UT), and interpreters. These users may access platform 200 in order to utilize end terminals 105, test equipment 107, or components 201-213 of platform 200 to conduct and manage one or more urodynamic studies. In other embodiments, platform 200 may connect all users to a substantially uniform, web-based, real-time system; can organize the scheduling for urodynamic procedures; can facilitate data input or organizational document generation; and can automate and streamline diagnostic analyses and payment methods. In the proceeding paragraphs, the various functions of platform 200 will be described with respect to the aforementioned user categories.

Primary Care Physicians

Primary care physicians (PCP) are general practitioners who provide a first contact for patients suffering from undiagnosed health concerns. In most instances, PCPs can properly identify and provide continuing care for a patient's ailments. Patients, in turn, typically build trusting relationships with their PCPs during the course of treatment. Unfortunately, most PCPs lack enough specialized knowledge to treat specific organ systems, such as the neurological or genitourinary systems. Thus, primary care physicians presented with urological disorders generally only conduct basic diagnostic procedures including: interviewing the patient to collect symptomatic conditions and a prior medical history, obtaining the patient's vital statistics, and performing a basic physical examination.

In order to facilitate the aforementioned, platform 200 is configured to provide PCPs with one or more input mechanisms for conducting general diagnostic procedures. According to one embodiment, user interface module 213 via, for example, one or more GUIs may be configured for this purpose. In this manner, a PCP may employ one or more client devices (e.g., end terminal 105) to enter and track a detailed collection of objective and subjective indicia concerning patient symptoms, medical history, vital statistics, and physical examination observations. It is also contemplated that a patient may utilize end terminal 105, which may be made available to the patient by their PCP, for entering the same before, during, or after speaking with their physician. According to other embodiments, patients may be provided limited access to platform 200 via authentication module 201. As such, the patient may interface with user interface module 213 to input, for example, basic personal information and/or objective and subjective symptoms they have been experiencing. The patient may input this information from one of their own client devices, such as one of their own personal computing devices, telephony devices, mobile devices, or other like mechanisms having connectivity to one or more of communication networks 111. In this manner, patients may be permitted to disclose embarrassing symptoms and transmit mundane personal information to platform 200 and, thereby, to their PCP, UT, and interpreter from the comfort and privacy of their own home.

It is noted that this information may be stored to user profiles repository 113 in patient profile 115 associated with the patient. Patient profile 115 may be linked or otherwise associated with a PCP profile 119 associated with their primary care physician. According to exemplary embodiments, general background information regarding the patient may include the patient's name, social security number, birth date, age, sex, contact information (e.g., home/work address, telephone number, email address, etc.), occupation, guardian, emergency contacts, insurance carrier, policy number, and the like. Moreover, at a typical “first” patient visit, a PCP may also obtain additional assets, such as a copy, image, scan, or other duplicate form of a patient's insurance card, as well as obtain a signed payment policy or distribute a privacy policy. In this manner, one or more GUIs may be provided by user interface module 213 to facilitate collection and/or distribution of these assets.

For instance, end terminal 105 may include or be coupled to a duplicating apparatus (not shown), such as a scanner, photocopier, reprographic camera, etc., configured to obtain and/or transfer digitized images to end terminal 105 and/or user interface module 213. In other instances, end terminal 105 may include or have communication with a touch screen, touch panel, or other digitizing tablet configured to capture and/or transmit a patient's signature (or other drawn graphic) to end terminal 105 and/or user interface module 213. In this manner, end terminal 105 may also include or be coupled to a document source technology (not shown), such as a printer, designed to supply hard copy privacy policies, testing documents, and/or duplicates of the aforementioned. Alternatively, these peripheral apparatuses may have direct access to one or more of communication networks 111 for uploading (or downloading) the same to (or from) end terminal 105, platform 200, and/or user profiles repository 113.

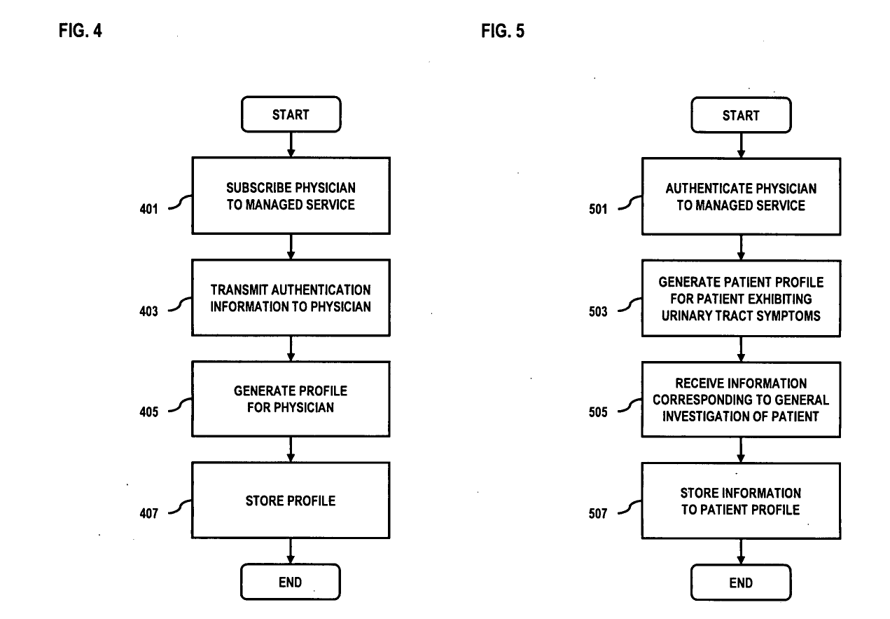

Accordingly, PCPs may subscribe to the managed service of system 100 to schedule urodynamic studies for one or more of their patients. As such, these PCPs may generate one or more user profiles, such as a PCP profile and a patient profile, for carrying out the processes described herein. FIGS. 4 and 5 are flowcharts of respective processes for generating physician and patient profiles, according to exemplary embodiments. For illustrative purposes, these processes are described with reference to FIGS. 1 and 2. It is also noted that the steps of these processes may be performed in any suitable order, as well as combined or separated in any suitable manner.

FIG. 4 is a flowchart of a process for generating a physician profile, according to an exemplary embodiment. At step 401, platform 200 subscribes a new user (e.g., a PCP) to the managed service of system 100. This may be a one-time registration process to ensure parties wishing to be participants of the managed service and utilize the benefits of a community of specialized urodynamic technicians and interpreters need only register once. According to one embodiment, the PCP may subscribe utilizing a client device capable of processing and transmitting information over one or more of communication networks 111, such as end terminal 105. Namely, the user may interact with an input interface of, for example, end terminal 105 to activate software resident on the device, such as a GUI or other networked application implemented by platform 200 via user interface module 213. The software may then enable sufficient connections to platform 200 over communication networks 111. As such, the user may register as a new subscriber of the managed medical diagnostic service, as well as obtain sufficient authentication information for establishing future sessions. In certain embodiments, registration procedures may prompt the PCP to identify all client devices (e.g., end terminal 105, mobile end terminal 107, and test apparatus 109) that the user may employ to interact with system 100. As such, registered devices (such as client devices 105-109) may be logically associated with the PCP.

Once registered, platform 200 enables the PCP, per step 403, to generate PCP profile 119 for managing one or more urodynamic studies, such as inputting basic diagnostic information for patients, scheduling urodynamic studies for patients, and receiving reports corresponding to urodynamic studies performed on the patients. In general, PCP profile 119 may be created by the PCP filling out a standardized form provided by a system administrator. Apart from general information regarding the physician, PCP profile 119 may also store one or more sub-profiles for patients seen by the PCP, or may be linked to one or more separate patient profiles. Furthermore, PCP profile 119 may include one or more adjustable user settings designated by each physician. These settings may relate to how various embodiments of user interface 103 are presented to the physician, as well as how the physician intends to input information to and extract information from platform 200 and/or user profiles repository 113. As such, participating PCPs may obtain corresponding usernames and passwords for future “log in” purposes, which provides the PCPs with appropriate levels of security access. Thus, per step 405, platform 200 via, for example, communication interface 203, stores PCP profile 119 to a suitable storage location, such as user profiles repository 115, memory 207, and/or one or more memories (not illustrated) of client devices 105 and 107.

Accordingly, when a patient visits a PCP exhibiting symptoms characteristic of a urinary tract disorder, such as urinary incontinence, the PCP may generate a profile for the patient, e.g., patient profile 117. FIG. 5 is a flowchart of a process for generating a patient profile, according to an exemplary embodiment. In step 501, authentication module 201 authenticates the PCP to the managed service of system 100 via, for instance, user input to a GUI of user interface module 213 that may interface with authentication module 201 for purposes of authentication (or authorization). It is noted, however, that authentication may be implicitly performed. For example, authentication may be assumed when a user navigates from one service or feature of platform 200 to another, or when a user accesses a service or feature of platform 200 via a previously authenticated device (e.g., end terminal 105) or connection. Once authenticated, the GUI enables the PCP to build and configure patient profile 115.

Based on information input to the GUI, user interface module 213 may, in step 503, generate patient profile 115 for the patient. For instance, the information may include at least one urinary tract symptom experienced by the patient. According to exemplary embodiments, patient profile 115 may, in general, be configured to store various content, such as objective and/or subjective symptomatic and diagnostic indicia, scheduling information for scheduling one or more urodynamic studies on the patient, information collected during urodynamic studies on the patient, reports generated based on conducted urodynamic studies, general patient information, and the like. Accordingly, the PCP may conduct a general investigation of the patient to determine whether a urodynamic study is required. Information collected by the PCP during the general investigation may be received by, for example, communication interface 203, per step 505. Thus, in step 507, this information may be stored to patient profile 115 of user profiles repository 113. Additionally (or alternatively), this information may be stored to any other suitable storage location, such as memory 207, one or more memories of client devices 105 and 107, etc. It is noted that patient profiles (e.g., patient profile 115) may be stored according to one or more associations, such as one or more associations with one or more PCPs, UTs, and/or interpreters handling at least some portion of the urodynamic study of the patient. It is also noted that these profiles and associations can be later used by platform 200 to reduce the possibility of input error, such as by “pre-entering” information to one or more GUIs that may be already be stored to one or more of these profiles.

FIGS. 6A-6F are diagrams of user interfaces for facilitating the processes of FIGS. 4 and 5, according to exemplary embodiments. As shown in FIGS. 6A-6F, an exemplary user interface 600 is provided, wherein authenticated users (e.g., primary care physicians and/or technicians) may review a particular clinic or physician's office's urodynamic test schedule, acquire and review payment policy signatures, acquire and review insurance card scans, conduct and review patient questionnaires, and/or acquire and review additional notes. User interface 600 may be invoked using a number of different methods. For example, a user may navigate to a webpage providing access to platform 200 through user interface 600. As such, an executing device (e.g., client devices 105 or 107) may require sufficient authentication information (e.g., username, password, etc.) to be input in order to access the functions of user interface 600. Accordingly, user interface 600 includes input fields 601 and 603 for a username and password, respectively. In alternative embodiments, input fields 601 and 603 may be configured to correspond to associated authentication information, such as entering a MAC address and password, etc. As previously mentioned, authentication may be implicit and, therefore, input fields 601 and 603 may be pre-populated or provided as, for example, a “welcome” field (not shown), e.g., “WELCOME USERNAME,” wherein “USERNAME” can be made to dynamically correspond to the implicitly authenticated user.

In the illustrated embodiment, user interface 600 may include one or more interactive panes, such as panes 605 and 607. In particular embodiments, as will be described in more detail below, the content of pane (area or box) 607 may be dynamically updated to display various information related to actions conducted within pane 605, and vice versa. Pane 605 (i.e., a navigation and control pane) includes a listing of selectable entries corresponding to one or more configurable parameters (or options) that may be associated with a subscription service, such as those parameters previously mentioned. In other embodiments, pane 605 may include a navigation tree, an expandable table of contents, or FlashMedia presentation of selectable entries. Based on a particular selection within pane 605, pane 607 (i.e., a review and modification pane) may be populated with appropriate input fields, selectable elements (e.g., toggle buttons, check boxes, radio buttons, sliders, list boxes, spinners, drop-down lists, menus, toolbars, ribbons, combo boxes, icons, etc.), output fields (e.g., labels, tooltips, balloon helps status bars, progress bars, infobars, etc.) and windows, as well as any other suitable interface widget for inputting (or otherwise perceiving) configurable parameters. In turn, actions within pane 607 may affect selectable parameters within pane 605.

Navigational elements/fields, e.g., scrollbars 609 and 611, as well as tabs 613a-613f, may be provided and configured to indicate the existence of additional entries not displayed, but navigably available, as well as facilitate interface usability. Accordingly, users may browse to these entries via, for instance, an input interface of a client device 105 or 107, such as a cursor control. One or more fixed focus states (e.g., border 615) and/or distinctive magnification features, e.g., color, brightness, bolding, font type, text size, etc., may be used to convey a “currently” navigated position or parameter to be entered. In certain embodiments, a plurality of graphical elements may be provided to correspond to the one or more options and/or configurations of the subscription service to aid usability, and thus may be displayed therewith.

In this manner, when a user navigates to a desired entry, actuation of, for instance, a “SCHEDULE” tab 613a may be provided for users to review a particular clinic or physician office's urodynamic test schedule by, for example, patient and appointment 617 (e.g., patient name, identification number, and scheduled time). This scheduling information may be extracted from user profiles repository 113 or any other suitable memory of system 100, such as memory 207. Upon initialization of pane 607, associated functional icons 619-625 may be integrated to the schedule. For instance, a “P” icon 619 may be provided for accessing a payment policy signature task, an “I” icon 621 for accessing an insurance card scan task, a “Q” icon 623 for accessing a patient questionnaire task, and an “N” icon 625 for accessing a notes task, as well as other like functions. It is noted that while task 619-625 are described as primarily performed by PCPs, a UT may be required to input supplemental information to further their urodynamic investigations. When task 619-625 are executed and completed, the color of a particular icon may change, e.g., from red to black, such as from yellow to green, for instance blue to orange, etc. The schedule may also present a number of studies 627 that are scheduled for the patient.

Accordingly, user interface 600 may also permit users to toggle between dates and times of day being displayed utilizing drop-down lists 629 and 631, for instance. While only a limited number of time slots are depicted, each capable of displaying a single patient appointment, it is contemplated that any number of times, time periods, or number of patient appointments are feasible. Alongside a patient's name, appointment time slot, and identification number column 617, a status column 633 organizes functional icons 619-625 in a toolbar like fashion. By activating a particular icon, a user may access associated functions and tasks. For ease-of-use and manipulation, patient appointments may be “unscheduled” or “rescheduled” by a via an associated icon 635, for example an “x” icon or “trash can” icon. In rescheduling embodiments, users may be given access to the functions and user interfaces associated with “SCHEDULER” tab 809c of FIG. 8B. Also, a refresh page icon 637 is provided for updating the pane 607, as well as user profiles repository 113, with the most “current” information. A date may be displayed to date field 639.

Actuating “INSURANCE CARD SCAN” tab 613c or “I” icon 621 provides for an import image task via panes 605 and 607. The import image task may be geared towards acquiring digital images of a patient's insurance card. It is noted that users may utilize the image acquire task for a host of imaging purposes; however, this need not be the case. In this manner, pane 605 may provide for one or more controls for acquiring and/or reviewing digital images of, for example, an insurance card. A “SCAN” control 641 may be actuated to initiate a duplicating sequence on one or more of the duplicating apparatuses to analyze, capture, and convert an image or object, such as an insurance card, into a digital image format. As such, pane 607 is provided for displaying one or more duplication results, such as a front and back image of an insurance card. Additionally (or alternatively), pane 607 may be utilized to review previously acquired images recalled from, for instance, user profiles database 113. A “REVIEW” control 643 may be actuated for this purpose. Digital images may be stored to user profiles repository 113 by actuating “SAVE” control 645. It is noted, however, that the images may be stored to any suitable repository of system 100. Meanwhile, a “CANCEL” control 647 can be utilized to terminate a duplication procedure. In other embodiments, a delete button may be provided for discarding unwanted or unnecessary images. Further, a field 649 (e.g., a check box or radio button) may be actuated when a patient insurance card has been previously acquired or will be at a later point in time.

Exemplary embodiments of user interface 600 also help to improve the efficiency of generating payment policy statements, prescriptions, referral forms, or other organizational documents by migrating storage of the same to an electronic medium. In this manner, the time and effort necessary to store and access the documents are reduced and further, by making the documents available to a plurality of authorized users needing such forms, overall efficiency may be increased. User profiles repository 113 (or any other suitable memory) may be configured to store a library of these electronic documents for data input and/or electronic signature. If necessary, users may generate hard copies of any of the organizational documents utilizing end terminal 105 and/or source technology with access to the network

In one embodiment, user interface 600 can create automated organizational documents once a patient is registered to the system. As shown in FIG. 6C, an exemplary task configured for displaying and signing organizational documents is schematically illustrated, according to an embodiment of the invention. The task includes an organizational document presented via pane 607. The document can include at least one region for receiving a signature. When implemented, a user may select one or more of the organizational forms stored in user profiles repository 113, such as a payment policy statement, for display in pane 607. In turn, another user, such as a patient, may electronically sign the document utilizing, for instance, a digitizing tablet. In other embodiments, additional regions may be included on the organizational document and may be populated utilizing the digitizing tablet or other input method of an accessing end terminal 105. These regions may include: a credit card number region, a payment method region, a region for entering symptomatic conditions, prior medical history, vital statistics, and/or any other type of general information region, such as a notes region

It is noted that data fields of an organizational document may be pre-populated by user interface module 213 upon loading. For instance, date fields may be filled when a patient gets ready to electronically sign a document. In alternative embodiments, executing the task on one end terminal may cause another to display the same, wherein a user may electronically sign or input data/information utilizing an end terminal 105 or module thereof.

In exemplary embodiments, when “P” icon 619 is selected, a payment policy task may be implemented, whereby a signature of the patient may be acquired. User interface 600 may toggle to the exemplary user interface of FIG. 6C. It is noted that a “PAYMENT POLICY” tab 613d may also be provided for accessing the payment policy task. For UTs, the payment policy task may be a condensed version of the task provided to PCPs. Since a UT may only need to acquire a patient's signature on a payment policy form, the task may be limited to such a function, but need not be. Accordingly, a user may utilize, for example, a digitizing tablet and/or end terminal 105 for displaying a payment policy to pane 607 that a patient may then electronically sign. As such, pane 605 may present one or more controls, e.g., an “ACQUIRE SIGNATURE” control 651 for importing digitized information (e.g., a signature) obtained via the digitizing tablet, a “REVIEW” control 653 for reviewing signed payment policies, a “SAVE” control 655 for saving signed payment policies to, for example, user profiles repository 113 or any other suitable memory of system 100, and a “CANCEL” control 657 for canceling the payment policy task. While not illustrated, the payment policy task may include a delete button for discarding unwanted or unnecessary documents. A control 659 (e.g., a check box, radio button, or the like) may be provided for bypassing instances when information or a signature is unneeded or not desired.

User interface 600 may also gather information regarding prior medical history or vital statistics. Data concerning prior medical history may include: allergies (foods, environments, insects, pharmaceuticals, plants, etc.), statuses (e.g., pregnant/nursing, psychotic, etc.), previously prescribed or current medications (including over-the-counter substances), major injuries, surgeries, hospitalizations, immunizations, previously diagnosed conditions (e.g., respiratory, vascular/cardiovascular, gastrointestinal, integumentary, lymphatic/hematologic, cancer, constitutional, genitor/urinary, bones/joints/muscles, allergic/immunologic, auto immune, psychiatric, etc.), social exposures (alcohol, illegal drugs/substances, tobacco, sexually transmitted diseases, etc.), pertinent family medical histories including genetically related diseases (e.g., arthritis, auto immune disorders, cataracts, cancer, high blood pressure/cholesterol, kidney disease, etc.), and other like information.

Meanwhile, data regarding vital statistics may include: age, height, weight, weight distribution among various tissues (muscle, fat, bone and marrow, internal organs, connective tissue and skin, blood), body weight distribution (head, neck, trunk, arms, legs), water content, area of skin, heart rate (resting), blood pressure (systolic, diastolic), cholesterol, glucose, triglycerides, high density lipoproteins (HDL), low density lipoproteins (LDL), bioimpedance, body mass index (BMI), etc. Additionally, a PCP may assign patient record/tracking numbers (or other privacy based monikers) to each patient record, record interview/examination dates and/or times, and enter physical observations or results from a physical examination in a notes interface, as well as perform other equivalent operations. The notes interface may, for example, be implemented as a text field, or capable of extracting information from a document created in a word processor.

Acquiring objective and subjective symptomatic information will be described with respect to FIGS. 6D and 6E. User interface 600 may be configured to gathering symptoms of urinary incontinence. As depicted, interface 600 categorizes illustrative objective and subjective UI symptoms into a series of topical groups concerning bladder function, sensations arising during micturition, and catalysts inducing involuntary urination. Each category comprises a list of symptoms proceeded by checkboxes. For example, if a patient has experienced “leaking urine,” one of the listed symptoms under bladder function, an indicating checkmark would be entered into the corresponding checkbox.

To cross reference patient responses, or provide an alternative method of eliciting symptomatic information, the questionnaire of FIG. 6E may also include targeted questions. Binary, “yes” or “no” responses may be input via radio buttons. For example, if a patient has ever experienced leaking urine as a result of activities such as exercising, straining, coughing, sneezing, or lifting, a “yes” button would be activated. While not depicted, the task may also include open-ended questions requiring specific answers or descriptions. Input text boxes may be provided for entering appropriate responses.

For instances when a patient has not experienced one of the listed symptoms, such an indication may be denoted in, for instance, an appropriate check box. Further, the task can provide fields for a patient name to be entered (or displayed) and/or a drop-down list for selecting a referring physician. Collection of data by user interface module 213 concerning medical history and/or vital statistic information may occur in similar fashions. In other embodiments, previous patient responses or other data entered to platform 200 may be later extracted from user profiles repository 213, for instance, wherein additional information may be added or existing data may be reviewed and modified.

Thus, user interface 600 may also include a “QUESTIONNAIRE” tab 613e (and/or “Q” icon 623) for accessing an objective and subjective symptomatic information questionnaire task. Users may acquire responses in pane 607 via exemplary questionnaire illustrated in FIG. 6E. Since PCPs generally perform this task, a UT may simply review, modify and/or supplement the information stored via this task. Once answers are input (or updated) and confirmed, the responses may be transmitted to platform 200 by actuating a “SAVE” control 659. A “REVIEW” control 663 may be provide or retrieving a questionnaire previously filled out by a particular patient from, for example, user profiles repository 113. A “CANCEL” control 667 may be provided for canceling the objective and subjective symptomatic information questionnaire task. Likewise, if a questionnaire has already been acquired and stored to user profiles repository 113 for a particular patient, field 669 may be checked to indicate such a state.

Further, by implementing the “NOTES” tab 613f (or “N” icon 625), users may be supplied with one or more regions for manually entering information, such as during a urodynamic study. The notes task may also be utilized to enter specific information or notes that a users encounter during an investigation that should be brought to the attention of a PCP, UT, or interpreting physician. Additionally, user interface 600 may be configured to accept verbal commands for entering suitable data into entry fields within pane 605 or making selections via tabs 613a-613f. In other embodiments, interface 600 may include fields for targeted advertisements 671, fields for service provider logos 673, and any other suitable field for extending the managed service to subscribers and/or providers of the managed service, such as date fields, time fields, logout fields, etc.

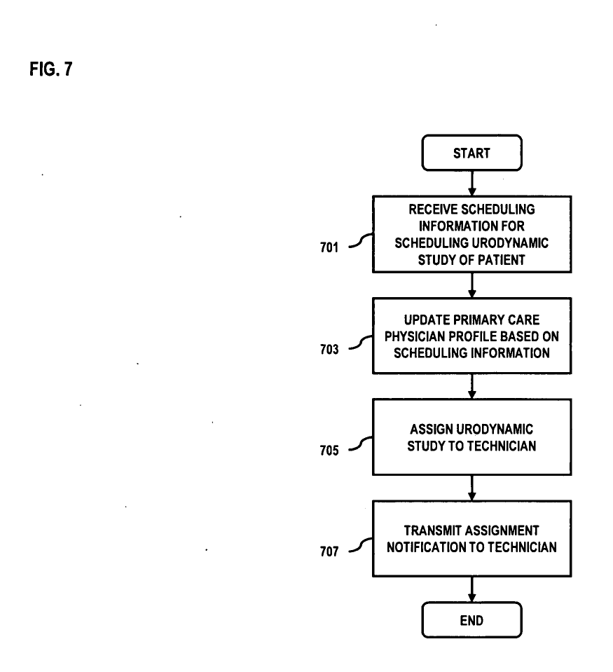

Accordingly, after a PCP conducts an initial set of investigative procedures, they may determine which patients require further urodynamic diagnostic examinations/studies. FIG. 7 is a flowchart of a process for scheduling urodynamic studies, according to an exemplary embodiment. For illustrative purposes, the process is described with reference to FIGS. 1 and 2. It is also noted that the steps of the process may be performed in any suitable order, as well as combined or separated in any suitable manner. At step 701, scheduling module 211 receives scheduling information for scheduling a urodynamic study of a patient. For example, a PCP via end terminal 105 may implement user interface 103 to generate a request including scheduling information for scheduling a technician to perform a urodynamic study at an office the PCP. In step 703, physician profile 119 is updated based on the scheduling information. It is also noted that the scheduling information may be provided to other suitable storage locations of system 100, such as memory 207. Per step 705, a technician is assigned to conduct the urodynamic study based on a plurality of requests associated with a plurality of physicians attempting to schedule one or more urodynamic studies. Thus, in step 707, a notification may be provided to the PCP and/or the technician to indicate the existence of and parameters relating to the scheduled urodynamic study.

FIGS. 8A-8E are diagrams of user interfaces for facilitating the process of FIG. 7, according to exemplary embodiments. As shown in FIGS. 8A-8C, an exemplary user interface 800 is provided, wherein authenticated users (e.g., primary care physicians) may view historical information relating to urodynamic study activity, create new/modify existing patient profiles for performing new urodynamic studies, schedule urodynamic studies, access generated reports corresponding to performed urodynamic studies, and modify one or more user settings affecting user interface 800. User interface 800 may be invoked using a number of different methods. For example, a user may navigate to a webpage providing access to platform 200 through user interface 800. As such, an executing device (e.g., client devices 105 or 107) may require sufficient authentication information (e.g., username, password, etc.) to be input in order to access the functions of user interface 800. Accordingly, user interface 800 includes input fields 801 and 803 for a username and password, respectively. In alternative embodiments, input fields 801 and 803 may be configured to correspond to associated authentication information, such as entering a MAC address and password, etc. As previously mentioned, authentication may be implicit and, therefore, input fields 801 and 803 may be pre-populated or provided as, for example, a “welcome” field (not shown), e.g., “WELCOME USERNAME,” wherein “USERNAME” can be made to dynamically correspond to the implicitly authenticated user.

In the illustrated embodiment, user interface 800 may include one or more interactive panes, such as panes 805. In particular embodiments, as will be described in more detail below, the content of pane 805 may be dynamically updated to display various information related to actions conducted within pane 805. According to exemplary embodiments, pane 805 may include a listing of selectable entries corresponding to one or more configurable parameters (or options) that may be associated with a subscription service, such as those parameters previously mentioned. In other embodiments, pane 805 may include a navigation tree, an expandable table of contents, or FlashMedia presentation of selectable entries. Based on a particular selections within pane 805, other information presented via pane 805 may be populated with appropriate input fields, selectable elements (e.g., toggle buttons, check boxes, radio buttons, sliders, list boxes, spinners, drop-down lists, menus, toolbars, ribbons, combo boxes, icons, etc.), output fields (e.g., labels, tooltips, balloon helps status bars, progress bars, infobars, etc.) and windows, as well as any other suitable interface widget for inputting (or otherwise perceiving) configurable parameters. In turn, actions within pane 805 may affect selectable parameters within pane 805.

Navigational element/field, e.g., scrollbar 807, as well as tabs 809a-809e, may be provided and configured to indicate the existence of additional entries not displayed, but navigably available, as well as facilitate interface usability. Accordingly, users may browse to these entries via, for instance, an input interface of a client device 105 or 107, such as a cursor control. One or more fixed focus states (e.g., border 811) and/or distinctive magnification features, e.g., color, brightness, bolding, font type, text size, etc., may be used to convey a “currently” navigated position or parameter to be entered. In certain embodiments, a plurality of graphical elements may be provided to correspond to the one or more options and/or configurations of the subscription service to aid usability, and thus may be displayed therewith.

In this manner, when a user navigates to a desired entry, actuation of, for instance, a “HOME” tab 809a may be provided for users to review historical data corresponding to the urodynamic studies one or more physicians have ordered. According to particular embodiments, the physicians may relate to the physicians of a single or multiple offices. As seen in FIG. 8A, users may selectively adjusted (or otherwise control) a temporal period for viewing the historical information, via “FROM” input field 813 and “TO” input field 815, that create corresponding start and ending points for a desired temporal period. Based on a configured temporal period, table 817 and graphical visualization 819 may be populated to respectively illustrate the ordering activity of urodynamic studies by the physicians individually and as an entity, e.g., as an office, over granulated subintervals (e.g., years, months, days, etc.) of the configured temporal period. For instance, during the displayed temporal period, “PHYSICIAN ‘2’” might have ordered five urodynamic studies out of a total of 48 studies ordered by an office of “PHYSICIAN ‘2.’” It is noted that the display and/or parameters affecting the display of table 817 and graphical visualization 819 may be configured by accessing “USER SETTINGS” tab 809e.

User interface 800 also includes a “SCHEDULER” tab 809c for scheduling urodynamic studies with technicians of the managed service of system 100. For instance, as seen in FIG. 8B, when a user actuates tab 809c, pane 805 provides an interface for scheduling urodynamic studies to one or more time slots 821, such as “SLOT ‘1’” to “SLOT ‘N.’” As such, drop-down lists 823 and 825 may be provided for selecting a scheduling month and year, while toggle buttons 827 may be actuated for selecting between scheduling days 829. In this way, configuration of a temporal period via input or interaction fields 823-829 dynamically presents corresponding scheduling slots 821 for scheduling one or more urodynamic studies. Scheduling icons (e.g., scheduling icon 831) may be provided for scheduling a urodynamic study. In this way, icons 831 may be presented alongside time slots available for scheduling. For “already” scheduled time slots, information corresponding to the patient, such as their name 833 and identification number 835 may be provided, as well as other information, such as referring physicians, requested technicians, start times, end times, durations, dates, and the like. As such, status information 837 may be presented for indicating scheduled (or unavailable) slots and not scheduled (or available) slots. Scheduled slots may be denoted as “SCHEDULED,” while not scheduled slots may be denoted as “OPEN.”

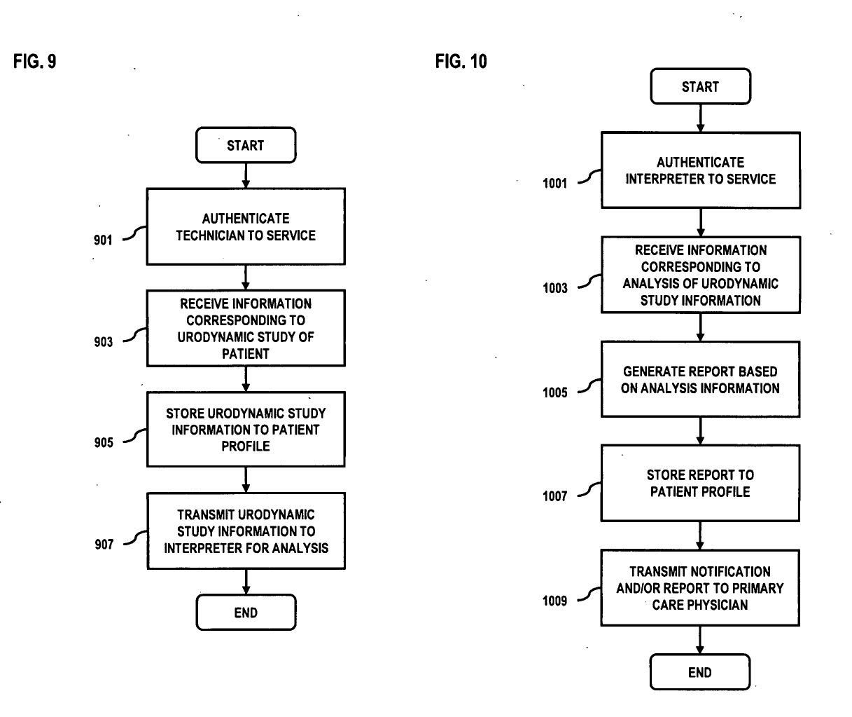

According to various embodiments, a “REPORT MANAGER” tab 809d may also be included for notifying users of completed reports corresponding to performed urodynamic studies. In this way, when a user actuates tab 809d, pane 805 provides an interface for users to display and/or review specific summaries, i.e., urodynamic reports, or uroanalysis information and differential diagnoses assembled from a information stored to a particular patient profile (e.g., patient profile 115). A drop down list 839 can be provided for reviewing reports generated over a specified time period, e.g., the last 30 days, the last six months, the past year, etc. These summaries may be automatically generated by reporting module 205 or assembled by a trained interpreter. A more detailed explanation of report generation will be provided with respect to FIGS. 9-11. Whatever the instance, a report may be displayed to a user after executing a “uroanalysis” icon 841. Alternatively, raw data extracted from a diagnostic procedure may be reviewed by executing a “raw report” icon 843. Accordingly, a list of available reports 845 may be generated and include information, such as report dates and times 847, patient identification numbers 849 (and/or names) and associated dates of birth (DOB) 851, referring physicians 853, as well as other like information, such as the technician who performed the urodynamic study on the patient, the interpreter who analyzed the information collected by the technician, etc. An exemplary report 870 is illustrated in FIG. 8D and may include general reporting information 871, background information 873 corresponding to the patient, and the results 875 of one or more urodynamic studies. While not shown, the report may also include diagnostic response information, such as one or more differential diagnoses, one or more treatment options, etc.

User interface 800 may also include a “USER SETTINGS” tab 809e for accessing one or more configurable settings that may be modified for the customization of the various interfaces of FIGS. 8A-8C displayed to particular users or organizations when “logged on” to platform 200. It is noted that selection of “NEW STUDIES” tab 809b causes user interface 800 to navigate to and, thereby, become user interface 600. Additionally, user interface 800 may be configured to accept verbal commands for entering suitable data into entry fields within pane 805 or making selections via tabs 809a-809e. In other embodiments, interface 800 may include fields for targeted advertisements 877, fields for service provider logos 879, and any other suitable field for extending the managed service to subscribers and/or providers of the managed service, such as date fields, time fields, logout fields, etc.

Urodynamic Technicians

Urodynamic technicians (UT) are practitioners who have completed advanced training to become certified specialists in conducting urodynamic diagnostic procedures. These individuals have a relatively practical understanding of urinary functions but are generally more highly versed in urodynamic testing techniques than PCPs. As such, system 100 enables patients to visit their PCPs for basic diagnostic procedures, but allows PCPs to utilize a specialized UT for conducting urodynamic procedures; the procedures being performed, for example, at an office of the PCPs of the patients. System 100 further enables UTs to perform these examinations in more hospitable environments tailored to a particular patient's level of comfort, embarrassment, and/or desire for increased privacy.

System 100 may facilitate a UT in acquiring urodynamic test data. For instance, user interface module 213 (in conjunction with communication interface 203) may be configured to receive real-time, ported data from test apparatus 107 as it is acquired or after a urodynamic study has been completed. Information collected by the technician may be processed test apparatus 107 and may be generally divided into different categories, i.e., complex uroflowmetry data, complex cystometrogram data, leak point pressures, urethral pressure profile data, EMG data, and pressure/flow data. Furthermore, urethral analysis information may include data pertaining to sphincter tone, sphincter reflex excitability, sensitivity, urethral length (including obstruction vs. weakness), anatomical distortions, and subjective impressions. Bladder analysis information can include reflex excitability, sensation, and compliance (tone). Meanwhile, flow rate information may also comprise an average, and a peak rate, as well as patterns exhibited over the voiding period. Furthermore, both objective and subjective criteria may be transmitted to platform 200 via user interface module 213 and/or communication interface 203.

FIG. 9 is a flowchart of a process for managing urodynamic study information, according to an exemplary embodiment. At step 901, a technician is authenticated to the managed service of system 100 via, for instance, user input to a GUI of user interface module 213 that may interface with authentication module 201 for purposes of authentication (or authorization). It is noted, however, that authentication may be implicitly performed. For example, authentication may be assumed when a user navigates from one service or feature of platform 200 to another, or when a user accesses a service or feature of platform 200 via a previously authenticated device (e.g., end terminal 105) or connection. Once authenticated, the GUI enables information collected by the technician during the urodynamic study to be received by, for instance, communication interface 203 (per step 903). In step 905, the information is stored to user profiles repository 113, e.g., patient profile 115. Additionally (or alternatively), the information may be stored to any other suitable memory of system 100, such as memory 207, one or more memories of client devices 105 and 107, etc. Thus, per step 907, the information may be transmitted to an interpreter for analysis.

Interpreters

Interpreters are physicians who specialize in particular fields of medicine, such as urology, neurology, etc. Interpreters are, more specifically, physicians exhibiting advanced training and/or expertise in continence care, e.g., female continence care. In conventional referral systems, patients will typically see their PCP first, and if a specialized treatment or advanced diagnosis is required, the patient will be sent to a medical specialist. Embodiments of the invention enable patients to maintain interaction with PCPs, i.e., those physicians they have built a trusting relationships with during the course of previous treatments, while obtaining the benefits of the advanced knowledge possessed by medical specialists.

In exemplary embodiments, interpreting physicians may review information collected by a technician during a urodynamic study to generate a patient diagnosis and recommended treatment in a report summarizing the results of a urodynamic diagnosis procedure. In alternative embodiments, the report may be automatically generated by report building module 205 for presentation to a PCP which may also detail a course of treatment. A report may include both narrative explanations, as well as figures indicating the various urodynamic readings, such as flow patterns, obstruction patterns, sphincter excitability, and other graphic patterns indicating the relevant urinary tract dysfunction exhibited by the patient. Additionally, the report may be displayed on a computer screen, printed on paper, transmitted by electronic-mail, generated in HTML as a web page, or provided in an equivalent means over one or more of communication networks 111.

Report building module 205 may also link with a medical reference database or third party web server to create a list of medical references and/or abstracts pertinent to a particular patent's condition. The references may be included within a report or an appendix attached thereto. In particular embodiments, the additional references may be provided as a list of hyperlinks permitting PCPs to immediately access and review the references. Analysis may also be based upon and compared to a repository of patient groupings with similar conditions to evaluate the efficacy of treatments, experiments, or trials, for example, surgical correction, drug products, mechanical devices, implant electrical stimulation, biofeedback, drug delivery systems, bulking agents, and insertable devices.

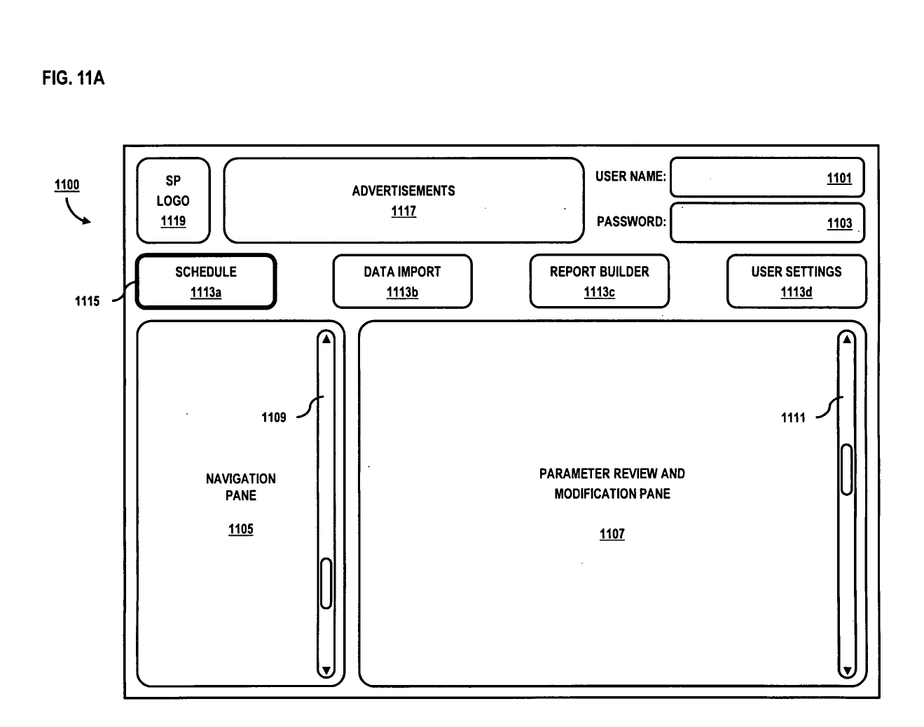

FIG. 10 is a flowchart of a process for generating urodynamic study reports, according to an exemplary embodiment. For illustrative purposes, the process is described with reference to FIGS. 1 and 2. It is also noted that the steps of the process may be performed in any suitable order, as well as combined or separated in any suitable manner. At step 1001, an interpreter is authenticated to the managed service of system 100, i.e., authenticated to platform 200 by, for example, authentication module 201. For example, user may be authenticated to the manage service of system 100 via user input to a GUI of user interface module 213 that may interface with authentication module 201 for purposes of authentication (or authorization). It is noted, however, that authentication may be implicitly performed. For example, authentication may be assumed when a user navigates from one service or feature of platform 200 to another, or when a user accesses a service or feature of platform 200 via a previously authenticated device (e.g., end terminal 105) or connection. Once authenticated, the GUI enables the interpreter and/or report building module 205 to review at least some content (e.g., information collected by a technician during a urodynamic study) for the purpose of generating a diagnostic response.

Accordingly, in step 1003, information corresponding to an analysis of the urodynamic study is received by communication interface 203, i.e., the diagnostic response, such as a differential diagnosis, one or more treatment regimens, etc. Per step 1005, a report is generated by, for example, reporting module 205 and/or user information module 213 based on the information received from the interpreter and/or generated by reporting module 205. At step 1007, the report is stored to a suitable storage location, such as patient profile 115 of user profiles repository 113. Thus, in step 1009, a notification of an available report and/or the report itself is transmitted to the PCP of the patient, such as transmitted to the PCP over one or more of communication networks 111.

FIGS. 11A-11G are diagrams of user interfaces for facilitating the processes of FIGS. 9 and 10, according to exemplary embodiments. As shown in FIG. 11A, an exemplary user interface 1100 is provided, wherein authenticated users (e.g., technicians and/or interpreters) may view scheduling information, upload/download information to/from platform 200, generate, modify, and/or review one or more reports, and modify one or more user settings affecting user interface 1100. User interface 1100 may be invoked using a number of different methods. For example, a user may navigate to a webpage providing access to platform 200 through user interface 1100. As such, an executing device (e.g., client devices 105 or 107) may require sufficient authentication information (e.g., username, password, etc.) to be input in order to access the functions of user interface 1100. Accordingly, user interface 1100 includes input fields 1101 and 1103 for a username and password, respectively. In alternative embodiments, input fields 1101 and 1103 may be configured to correspond to associated authentication information, such as entering a MAC address and password, etc. As previously mentioned, authentication may be implicit and, therefore, input fields 1101 and 1103 may be pre-populated or provided as, for example, a “welcome” field (not shown), e.g., “WELCOME USERNAME,” wherein “USERNAME” can be made to dynamically correspond to the implicitly authenticated user.

In the illustrated embodiment, user interface 1100 may include one or more interactive panes, such as panes 1105 and 1107. In particular embodiments, as will be described in more detail below, the content of pane 1107 may be dynamically updated to display various information related to actions conducted within pane 1105, and vice versa. Pane 1105 (i.e., a navigation pane) includes a listing of selectable entries corresponding to one or more configurable parameters (or options) that may be associated with a subscription service, such as those parameters previously mentioned. In other embodiments, pane 1105 may include a navigation tree, an expandable table of contents, or FlashMedia presentation of selectable entries. Based on a particular selection within pane 1105, pane 1107 (i.e., a parameter review and modification pane) may be populated with appropriate input fields, selectable elements (e.g., toggle buttons, check boxes, radio buttons, sliders, list boxes, spinners, drop-down lists, menus, toolbars, ribbons, combo boxes, icons, etc.), output fields (e.g., labels, tooltips, balloon helps status bars, progress bars, infobars, etc.) and windows, as well as any other suitable interface widget for inputting (or otherwise perceiving) configurable parameters. In turn, actions within pane 1107 may affect selectable parameters within pane 1105. It is noted that, in particular embodiments, only pane 1105 or 1107 may be provided.

Navigational elements/fields, e.g., scrollbars 1109 and 111, as well as tabs 1113a-1113d, may be provided and configured to indicate the existence of additional entries not displayed, but navigably available, as well as facilitate interface usability. Accordingly, users may browse to these entries via, for instance, an input interface of a client device 105 or 107, such as a cursor control. One or more fixed focus states (e.g., border 1115) and/or distinctive magnification features, e.g., color, brightness, bolding, font type, text size, etc., may be used to convey a “currently” navigated position or parameter to be entered. In certain embodiments, a plurality of graphical elements may be provided to correspond to the one or more options and/or configurations of the subscription service to aid usability, and thus may be displayed therewith.

In this manner, when a user navigates to a desired entry, actuation of, for instance, a “SCHEDULE” tab 1113a may be provided for users to review their work assignments, e.g., scheduling for the performance of one or more urodynamic studies or analysis of one or more previously conducted urodynamic studies. A “DATA IMPORT/EXPORT” tab 1113b is provided for users to upload or download information form or to platform 200. This information may also be stored to user profiles repository 113. For instance, the information may correspond to information collected by a UT during a urodynamic procedure. A “REPORT BUILDER” tab 1113c enables users, such as interpreters, to generate diagnostic responses, as well as review at least some of the content stored to patient profile 115. Exemplary interfaces for building a report are described in more detail in accordance with FIGS. 11B-11G. A “USER SETTINGS” tab 1113d for access one or more configurable settings that may be modified for the customization of the various interfaces of FIGS. 11A-11G, displayed to particular users or organizations when “logged on” to platform 200.

FIGS. 11B-11G provide exemplary panes 1105 and 1107 for generating, modifying, and reviewing reports and/or information collected by a technician during a urodynamic study of a patient. As depicted, various widgets enable interpreters to receive information concerning: a referring physician 1121, patient name 1123, patient age 1125, chief symptomatic complaints 1127, complex uroflowmetry information 1129 (e.g., residual volume, maximum flow rate, mean flow rate, voided volume, pattern of excretion, etc.), complex cystometrogram information 1131 (e.g., first urge volume, maximum cystometric capacity, a compliance level, where the catheter was inserted for testing and at what bladder volume, evidence of detrusor over activity, whether provocative measures were attempted to induce detrusor activity, etc.), leak point pressure information 1133 (e.g., leak points at various bladder volumes, a detrusor leak point, what patient position produced leak points, whether the prolapse was reduced, etc.), urethral pressure profile information 1135 (e.g., maximum urethral closure pressures for passive and dynamic states, pressure ratio between a vesical leak point pressure and a resting vesical pressure, etc.), whether EMG studies where utilized 1137; and pressure flow information 1139 (e.g., maximum flow rate, mean flow rate, a voiding mechanism, a voiding pattern, whether there was evidence of detrusor-external sphincter dyssynergia, and whether the voiding pattern was/was not suggestive of obstruction, etc.), as well as procedures performed 1141 (e.g., complex CMG, void pressure study, urethral proflometry, electromyography, intra-abdominal void pressure, complex uroflometry, etc.), and any UT notes stored to the system.

With the above information an interpreter may select from a list of impressions 1143 regarding possible differential diagnoses for the patient's urinary incontinence issues, provide treatment options 1145, specific recommendations 1147, as well as provide additional comments 1149. A report builder editor 1151 imports the information from fields (or regions) 1121-1149 to construct a finalized document in a narrative format. At this stage, the interpreter may modify the text of the narration. As previously mentioned, an exemplary end product is illustrated in FIG. 8D. Accordingly, generated reports can be stored to any suitable memory of system 100, such as memory 207, user profiles repository 113, and/or one or more memories of client devices 105 and 107 so that a PCP may access the report via, for example, the user interface of FIG. 8C. That is, generated reports, such as report 109, may be received at end terminal 105 and/or one or more of the peripheral interfaces of end terminal 105 that were previously described. For instance, report 109 may be printed using a source technology or read to a PCP utilizing an audile interface.

Interface 1110 may also include one or more navigation selections, such as a “SAVE” button 1153 for saving a “current” state the report building process, a “NEXT” button 1155 for traversing to a “next” GUI for inputting information to pane 1107, a “CANCEL” button 1157 to exit the report building process, and a “PREVIOUS” button 1159 for traversing back to a “previous” state of the report building process. Additionally, interface 1100 may be configured to accept verbal commands for entering suitable data into entry fields within pane 1107 or making selections within pane 1105. In other embodiments, interface 1100 may include fields for targeted advertisements 1117, fields for service provider logos 1119, and any other suitable field for extending the managed service to subscribers and/or providers of the managed service, such as date fields, time fields, logout fields, etc.

It is noted that platform 200 may also implement (or act in unison with) the aforementioned billing module and payment module to generate and include a statement of services and fees to the PCPs and/or patients. Further, by utilizing the insurance card images and associated policy information, the billing module and payment module may transmit a bill and request direct payment from an insurance carrier of the patient. In any case, an automated clearing house module, a wire transfer module, a debit card module, a credit card module, or any other suitable electronic funds transfer (EFT) module may be utilized for accepting payments and transferring funds between appropriate institutions, as is known.

The processes described herein for providing automated medical analysis may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 12 illustrates computing hardware (e.g., computer system) 1200 upon which an embodiment according to the invention can be implemented. The computer system 1200 includes a bus 1201 or other communication mechanism for communicating information and a processor 1203 coupled to the bus 1201 for processing information. The computer system 1200 also includes main memory 1205, such as a random access memory (RAM) or other dynamic storage device, coupled to the bus 1201 for storing information and instructions to be executed by the processor 1203. Main memory 1205 can also be used for storing temporary variables or other intermediate information during execution of instructions by the processor 1203. The computer system 1200 may further include a read only memory (ROM) 1207 or other static storage device coupled to the bus 1201 for storing static information and instructions for the processor 1203. A storage device 1209, such as a magnetic disk or optical disk, is coupled to the bus 1201 for persistently storing information and instructions.

The computer system 1200 may be coupled via the bus 1201 to a display 1211, such as a cathode ray tube (CRT), liquid crystal display, active matrix display, or plasma display, for displaying information to a computer user. An input device 1213, such as a keyboard including alphanumeric and other keys, is coupled to the bus 1201 for communicating information and command selections to the processor 1203. Another type of user input device is a cursor control 1215, such as a mouse, a trackball, or cursor direction keys, for communicating direction information and command selections to the processor 1203 and for controlling cursor movement on the display 1211.

According to an embodiment of the invention, the processes described herein are performed by the computer system 1200, in response to the processor 1203 executing an arrangement of instructions contained in main memory 1205. Such instructions can be read into main memory 1205 from another computer-readable medium, such as the storage device 1209. Execution of the arrangement of instructions contained in main memory 1205 causes the processor 1203 to perform the process steps described herein. One or more processors in a multi-processing arrangement may also be employed to execute the instructions contained in main memory 1205. In alternative embodiments, hard-wired circuitry may be used in place of or in combination with software instructions to implement the embodiment of the invention. Thus, embodiments of the invention are not limited to any specific combination of hardware circuitry and software.

The computer system 1200 also includes a communication interface 1217 coupled to bus 1201. The communication interface 1217 provides a two-way data communication coupling to a network link 1219 connected to a local network 1221. For example, the communication interface 1217 may be a digital subscriber line (DSL) card or modem, an integrated services digital network (ISDN) card, a cable modem, a telephone modem, or any other communication interface to provide a data communication connection to a corresponding type of communication line. As another example, communication interface 1217 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1217 sends and receives electrical, electromagnetic, or optical signals that carry digital data streams representing various types of information. Further, the communication interface 1217 can include peripheral interface devices, such as a Universal Serial Bus (USB) interface, a PCMCIA (Personal Computer Memory Card International Association) interface, etc. Although a single communication interface 1217 is depicted in FIG. 12, multiple communication interfaces can also be employed.

The network link 1219 typically provides data communication through one or more networks to other data devices. For example, the network link 1219 may provide a connection through local network 1221 to a host computer 1223, which has connectivity to a network 1225 (e.g. a wide area network (WAN) or the global packet data communication network now commonly referred to as the “Internet”) or to data equipment operated by a service provider. The local network 1221 and the network 1225 both use electrical, electromagnetic, or optical signals to convey information and instructions. The signals through the various networks and the signals on the network link 1219 and through the communication interface 1217, which communicate digital data with the computer system 1200, are exemplary forms of carrier waves bearing the information and instructions.

The computer system 1200 can send messages and receive data, including program code, through the network(s), the network link 1219, and the communication interface 1217. In the Internet example, a server (not shown) might transmit requested code belonging to an application program for implementing an embodiment of the invention through the network 1225, the local network 1221 and the communication interface 1217. The processor 1203 may execute the transmitted code while being received and/or store the code in the storage device 1209, or other non-volatile storage for later execution. In this manner, the computer system 1200 may obtain application code in the form of a carrier wave.

The term “computer-readable medium” as used herein refers to any medium that participates in providing instructions to the processor 1203 for execution. Such a medium may take many forms, including but not limited to non-volatile media, volatile media, and transmission media. Non-volatile media include, for example, optical or magnetic disks, such as the storage device 1209. Volatile media include dynamic memory, such as main memory 1205. Transmission media include coaxial cables, copper wire and fiber optics, including the wires that comprise the bus 1201. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

Various exemplary embodiments disclosed herein provide significant advantages over the present state of the medical community. Today, appropriate diagnoses and treatments are wholly dependent upon PCPs referring patients to appropriate technicians and expert physicians who may properly diagnose the patient's condition, but may still further refer the patient to another physician. The patient, in turn, may know nothing about these “other” technicians and physicians, and therefore, choose not to engage in beneficial diagnostic procedures and treatments to preserve a sense of personal dignity. Further, the level of expertise at each level of referral is limited to that individual's own study, research, and personal experience, which can be further limited due to time, practice specialty, geography, as well as other like considerations. Thus, exemplary embodiments described herein avoid these limitations by providing a user interface available to anyone, practically anywhere, through the use of standard communication networks and interfaces. As such, repetitive disclosure demands may be decreased because information may be shared, and shared confidentially. The analytical framework enables a thorough analysis of all relevant factors by a host of experts without requiring the patient to travel between these individuals. Further, because the user interfaces may be implemented almost anywhere, more comfortable test environments and procedures may be employed. Moreover, because the system can report all the information back to a PCP, a patient may maintain communication with the physicians they trust the most. Also, by incorporating a billing and payment system, additional efficiencies may be realized. Thus, there are disclosed enhanced, cost-effective techniques for automated medical analysis and, in particular, for assessing urinary functions.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

1. A method comprising:
receiving a request over a data network from a physician to schedule a urodynamic study on a patient as part of a managed service;
storing the request in a repository configured to store a plurality of requests corresponding to a plurality of physicians; and
scheduling a technician, based on the requests, to perform the urodynamic study at a location of the physician,
wherein information collected by the technician during the urodynamic study is stored in the repository to a patient profile.

2. A method according to claim 1, further comprising:
receiving, over the data network, at least one urinary symptom of the patient from the physician; and
storing the at least one urinary symptom to the patient profile.

3. A method according to claim 1, further comprising:
transmitting, over the data network, the information to an interpreter for analysis;
receiving, over the data network, a diagnostic response from the interpreter, and
generating a report including the diagnostic response and at least some of the information.

4. A method according to claim 3, further comprising:
subscribing the physician to the managed service over the data network;
transmitting, over the data network to the physician, authentication information for accessing a networked application,
wherein the networked application is selectively provided to the physician, based on the authentication information, for generating the request and viewing the report.

5. A method according to claim 1, wherein the managed service is a paid service to the physician and the urodynamic study is a paid service to the patient.

6. A method according to claim 1, wherein equipment to perform the urodynamic study is supplied by a provider of the managed service.

7. An apparatus comprising:
a scheduling module configured to schedule, as part of a managed service, a technician to perform a urodynamic study on a patient at a location of a physician based on a request received, over a data network, from the physician and one or more other requests, stored to a memory, corresponding to one or more other physicians; and
wherein information collected during the urodynamic study is stored to a profile corresponding to the patient.

8. An apparatus according to claim 7, further comprising:
a communication interface configured to receive, over the data network from the physician, at least one urinary symptom of the patient and to transmit the at least one urinary symptom to a repository configured to store a plurality of profiles corresponding to a plurality of patients,
wherein the at least one urinary symptom is stored to the profile.

9. An apparatus according to claim 7, further comprising:
a communication interface configured to transmit, over the data network, content stored to the profile to an interpreter for analysis and to receive, over the data network from the interpreter, a diagnostic response; and
a report building module configured to generate a report including the diagnostic response and at least some of the content.

10. An apparatus according to claim 9, further comprising:
an authentication module configured to provide the physician with selective access to a networked application; and
an online interface module configured to provide the networked application to the physician over the data network,
wherein the network application enables the physician to generate the request and view the report.

11. An apparatus according to claim 7, wherein the managed service is a paid service to the physician and the urodynamic study is a paid service to the patient.

12. An apparatus according to claim 7, wherein equipment to perform the urodynamic study is supplied by a provider of the managed service.

13. A method comprising:
transmitting, over a data network, a request to schedule a urodynamic study on a patient at a location of a physician; and
receiving, over the data network, scheduling information indicating a technician to perform the urodynamic study at a location of the physician,
wherein the scheduling information is generated based on a plurality of requests, including the request, corresponding to a plurality of physicians, including the physician.

14. A method according to claim 13, wherein information collected by the technician during the urodynamic study is stored in a repository to a patient profile including at least one urinary symptom of the patient, the method further comprising:
transmitting, over the data network, the at least one urinary symptom.

15. A method according to claim 13, further comprising:
receiving, over the data network, a report including a diagnostic response and at least some content stored to the patient profile,
wherein the diagnostic response includes a differential diagnosis and one or more treatment options.

16. A method according to claim 15, further comprising:
receiving, over the data network, authentication information for accessing a networked application,
wherein the networked application is selectively provided to the physician, based on the authentication information, for generating the request and viewing the report.

17. A method according to claim 13, wherein the managed service is a paid service to the physician and the urodynamic study is a paid service to the patient.

18. A method according to claim 13, wherein equipment to perform the urodynamic study is supplied by a provider of the managed service.
